(19) United States
(12) Patent Application Publication
(10) Pub. No.: US 2026/0290186 A1
(43) Pub. Date: Sep. 24, 2026

(54) SYSTEM

(71) Applicant: SoftBank Group Corp., Tokyo (JP)

(72) Inventor: Ryo KATO, Tokyo (JP)

(73) Assignee: SoftBank Group Corp., Tokyo (JP)

(21) Appl. No.: 19/567,355

(22) Filed: Mar. 16, 2026

(30) Foreign Application Priority Data
Mar. 19, 2025 (JP) 2025-045113

(51) Int. Cl. G09B 5/06; G06F 40/40

(52) U.S. Cl. CPC G09B 5/06; G06F 40/40

(57) ABSTRACT

A system includes a processor that is configured to generate a prompt for instructing a generative AI model to propose a learning plan based on a student's goals and academic ability, provide an instruction to the generative AI model using a prompt for generating personalized proposals in accordance with a student's needs and progress status, provide individually optimized learning materials and problems using the generative AI model, track a student's learning progress and provide feedback based on an analysis result using the generative AI model, analyze a student's emotional state in real time and use a prompt for instructing the generative AI model to optimize the learning plan and learning materials based on the emotional state, and provide appropriate feedback using the generative AI model based on an emotional analysis result.

### CROSS-REFERENCE TO RELATED APPLICATION

This application is based on and claims priority under 35 USC 119 from Japanese Patent Application No. 2025-045113 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-based learning systems and e-learning platforms generally provide static or semi-static learning content and plans that are only coarsely adapted to a student's grade level or past scores. Such systems typically fail to generate learning plans that are precisely tailored to an individual student's goals and academic abilities in real time. Furthermore, known systems do not sufficiently leverage generative AI models to dynamically create prompts, content, and feedback flows that adapt to a student's evolving needs and progress status. As a result, the personalization of learning experiences remains limited, and it is difficult to continuously optimize the learning path for each student. In addition, traditional systems usually do not consider a student's emotional state as an explicit parameter in the optimization of learning plans, learning materials, or feedback. Even if some systems gather engagement or satisfaction indicators, they rarely conduct real-time emotional analysis and they do not use generative AI models in a prompt-driven manner to adjust the content or strategies based on the detected emotions. Consequently, students may experience frustration, boredom, or anxiety without timely and appropriate intervention, and the overall learning effectiveness and efficiency may be reduced.

Moreover, there is a lack of an integrated mechanism that uses prompts to instruct a generative AI model to coordinate learning plan generation, personalized content delivery, progress tracking, feedback generation, and emotion-aware adaptation within a single coherent system. Existing solutions often address only one aspect, such as recommendation of exercises or simple feedback on correctness, and do not provide a comprehensive, prompt-controlled generative AI framework that focuses on maximizing the student's learning outcomes through efficient and effective learning experiences. This leads to a need for a system that can automatically generate structured prompts for a generative AI model and use those prompts to orchestrate goal-based personalization, progress-driven adaptation, and emotion-aware optimization.

### SUMMARY

In order to solve the above-described problems, the present invention provides a system comprising a processor, wherein the processor is configured to employ a generative AI model through systematically generated prompts to achieve integrated and highly personalized learning support.

In one aspect, the processor is configured to generate a prompt for instructing a generative AI model to propose a learning plan based on a student's goals and academic ability. In particular, the processor receives information representing a student's learning goals and academic level, converts this information into a structured prompt, and supplies the prompt to the generative AI model so that the generative AI model outputs a learning plan that is tailored to the student. By doing so, the system can generate individualized learning plans that reflect each student's specific objectives and current capabilities.

In another aspect, the processor is configured to provide an instruction to the generative AI model using a prompt for generating personalized proposals in accordance with a student's needs and progress status. The processor analyzes a student's learning history, current performance, and explicit needs, and the processor constructs prompts that cause the generative AI model to propose learning strategies, supplementary materials, or adjusted task sequences suitable for the student's current situation. The system thereby realizes fine-grained personalization that responds dynamically to the student's ongoing learning process. Additionally, the processor is configured to provide individually optimized learning materials and problems using the generative AI model. The processor generates prompts that specify required difficulty levels, topic scopes, and pedagogical styles, and the processor instructs the generative AI model to output or select learning materials and problems that match the specified parameters. This enables the system to supply, in real time, content that is optimized to the student's academic level and learning path.

Furthermore, the processor is configured to track a student's learning progress and to provide feedback based on an analysis result using the generative AI model. The processor accumulates performance data, such as scores, completion status, and response patterns, and the processor generates analysis results regarding mastery or weakness of particular topics. The processor then produces prompts that instruct the generative AI model to generate feedback messages, explanations, or next-step recommendations tailored to the analysis results, thereby delivering adaptive and context-sensitive feedback to the student.

The processor is also configured to analyze a student's emotional state in real time and to use a prompt for instructing the generative AI model to optimize the learning plan and learning materials based on the emotional state. The processor acquires emotional indicators, for example through sensor data, interaction logs, or explicit self-reports, and the processor performs emotional analysis to determine states such as frustration, boredom, or high engagement. Based on the detected emotional state, the processor generates prompts that instruct the generative AI model to adjust the difficulty, pacing, explanation style, or content type of the learning plan and materials, allowing the system to maintain or restore an optimal emotional and cognitive zone for learning.

Moreover, the processor is configured to provide appropriate feedback using the generative AI model based on an emotional analysis result. The processor constructs prompts that encode both the emotional analysis and the learning context, and the processor causes the generative AI model to generate supportive, motivating, or calming feedback messages suitable for the student's emotional condition. In certain embodiments, the processor further uses prompts to instruct the provision of an efficient and effective learning experience that maximizes a student's learning outcomes, and to instruct the generation and presentation of learning goals to the student in order to support the student's learning plan and goal setting. Through these combined prompt-based controls of the generative AI model, the system implements an integrated solution that simultaneously addresses goal-based personalization, progress-aware adaptation, and emotion-sensitive optimization, thereby solving the above-mentioned problems.

The term “processor” refers to any hardware, circuitry, microprocessor, microcontroller, CPU, GPU, AI accelerator, programmable logic, or combination thereof that is capable of executing instructions to perform the functions described herein.

The term “generative AI model” refers to a machine learning model, such as a large language model or other generative neural network, that is configured to generate outputs including text, questions, explanations, feedback, or learning materials based on input data and prompts.

The term “prompt” refers to data, including text, parameters, or structured instructions, that is supplied to a generative AI model in order to control or specify the content, style, or purpose of an output generated by the generative AI model.

The term “learning plan” refers to an organized set of learning activities, schedules, topics, and materials that are arranged over time for a student in order to achieve one or more learning goals.

The term “learning materials” refers to educational content, including but not limited to textual explanations, examples, multimedia resources, exercises, and practice problems, that is presented to a student for the purpose of learning.

The term “problems” refers to questions, exercises, or tasks that require a student to provide an answer, perform a calculation, or demonstrate understanding of a particular concept. The term “student's goals” refers to target outcomes or objectives related to learning, such as passing an examination, mastering a particular topic, or achieving a specified proficiency level, as specified by or for the student.

The term “academic ability” refers to a level of knowledge, skill, or proficiency of a student in one or more subjects or topics, which may be inferred from test scores, performance data, past learning history, or other indicators.

The term “student's needs” refers to specific requirements, difficulties, preferences, or requests of a student in the learning process, including desires for additional explanation, different difficulty levels, or deeper understanding of topics.

The term “progress status” refers to information indicating how far a student has advanced in a learning plan or course of study, including completed materials, current topics, and performance trends over time.

The term “personalized proposals” refers to recommendations, learning plans, content selections, or learning strategies that are adapted to the individual characteristics, goals, needs, or progress status of a particular student.

The term “individually optimized” refers to being adjusted or selected so as to be suitable for a specific student, taking into account that student's academic ability, goals, progress status, and other personal factors.

The term “learning progress” refers to changes in a student's knowledge, skills, or completion status over time, as measured or inferred from performance on problems, interaction logs, or other learning activities.

The term “analysis result” refers to information obtained by processing and evaluating data related to a student's learning progress, performance, or emotional state, such as mastery estimates, difficulty assessments, or engagement indicators.

The term “feedback” refers to information, messages, guidance, or evaluations provided to a student in response to the student's actions, performance, or state, with the aim of supporting or improving the student's learning.

The term “emotional state” refers to a psychological condition of a student, such as frustration, boredom, confusion, engagement, motivation, or satisfaction, at a given point in time during the learning process.

The term “emotional analysis result” refers to information obtained from analyzing data related to a student's emotional state, such as detected emotion categories, intensity levels, or temporal changes in emotion.

The term “efficient and effective learning experience” refers to a learning process that enables a student to achieve desired learning outcomes with improved speed, reduced unnecessary effort, and increased comprehension or retention compared to conventional approaches.

The term “learning outcomes” refers to measurable results of learning, including knowledge acquisition, skill improvement, test scores, mastery of topics, or attainment of specified learning goals.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

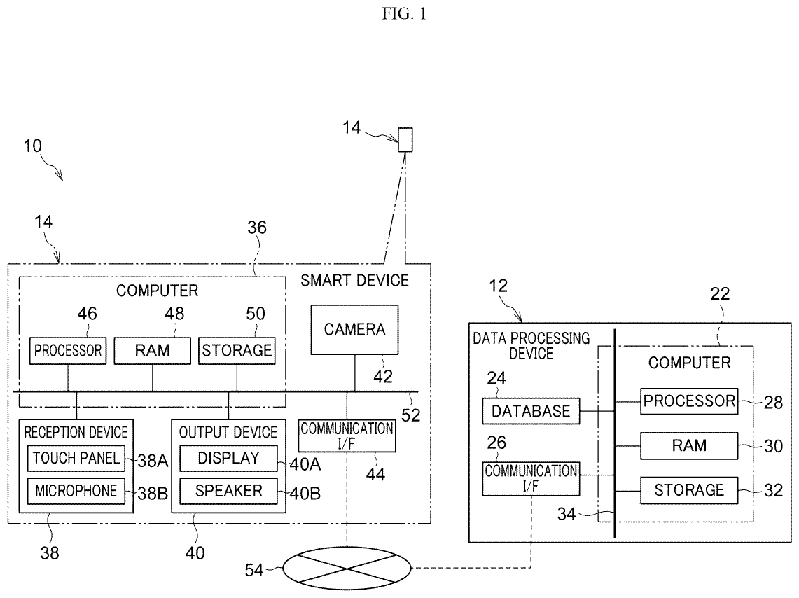

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

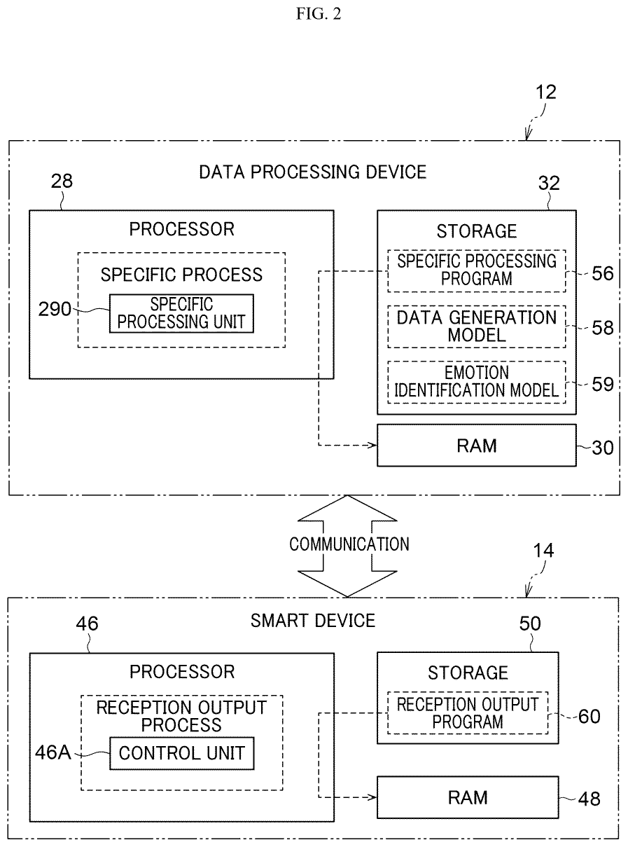

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning support systems typically rely on static rule-based engines or simple recommendation logic that selects learning materials from a fixed repository based on coarse-grained learner attributes such as grade level or past test scores. Such systems are not capable of dynamically generating and updating individualized learning plans at a fine-grained topic level in response to real-time learning progress. As a result, the systems often fail to allocate study time appropriately among learning fields, to adapt task difficulty based on the learner's evolving mastery, and to provide timely feedback that maximizes learning outcomes.

Moreover, known systems generally treat learner data as passive records and do not leverage advanced language-based models to interpret complex learning histories, infer weak and strong fields at a detailed level, and transform these inferences into concrete, actionable study plans. Even when generative AI models are used, they are often invoked in an ad hoc manner, without a structured, programmatic control flow using systematically generated prompt sentences that explicitly encode pedagogical constraints, evaluation criteria, and system-level optimization goals. This leads to inconsistent plan quality, lack of reproducibility, and difficulty in integrating the generative AI model into a robust, scalable server-side architecture.

In addition, existing systems commonly update learning plans manually or at fixed intervals, without a closed feedback loop that continuously incorporates fine-grained progress information, such as task-level completion status, newly obtained performance data, and self-evaluation information. Without such a loop, the system cannot efficiently recalibrate learning plans for the remaining period, and cannot computationally optimize learning efficiency or understanding degree using the full capabilities of a generative AI model. Accordingly, there is a need for a computer-implemented system and server-side processing architecture that: (i) programmatically generates and manages multiple types of prompt sentences to control a generative AI model; (ii) automatically derives degree-of-mastery information from stored learning histories and performance data; (iii) uses the generative AI model to identify strong and weak learning fields, generate an initial personalized learning plan, and iteratively update that plan based on real-time progress information; and (iv) thereby improves the functioning of the computer system itself by enabling the server to perform more efficient data aggregation, model interaction, and plan optimization processes than those achievable by conventional rule-based or static recommendation engines.

The specific processing by the specific processing unit 290 of the data processing device 12 in Example 1 is realized by the following means.

The present invention provides a server comprising a processor and a storage unit storing learning history information and performance information for each learner, wherein the processor is configured to execute instructions that cause the server to: acquire, from a learner-operated terminal, input information representing a learning objective, associate the input information with learner identification information and with the learning history information and the performance information stored in the storage unit, and generate, based on subject-wise or unit-wise performance information and study-time information obtained from the storage unit, degree-of-mastery information for each learning field by aggregating or classifying the performance information and the study-time information; generate a first prompt sentence for input to a generative AI model, the first prompt sentence being constructed from the learning objective, the degree-of-mastery information, and the learning history information and instructing the generative AI model to identify strong fields and weak fields among the learning fields, input the first prompt sentence and the degree-of-mastery information to the generative AI model, and obtain analysis-result information including the strong fields and the weak fields by natural language processing and statistical estimation processing performed by the generative AI model; generate a second prompt sentence for instructing the generative AI model to generate personalized learning-plan information including a learning period, allocation of study time, and learning contents for each learning field based on the analysis-result information and the learning objective, input the second prompt sentence to the generative AI model, and obtain the learning-plan information from the generative AI model; transmit the learning-plan information to the learner-operated terminal and cause the learner-operated terminal to display the learning-plan information as learning tasks on a daily basis or on a session basis; acquire, from the learner-operated terminal, progress information including achievement status of the learning tasks executed by the learner based on the learning-plan information, additional performance information, and self-evaluation information, and sequentially store the progress information in the storage unit as updated learning history information and updated performance information; and generate a third prompt sentence for instructing the generative AI model to update or modify the learning-plan information based on the updated learning history information and the updated performance information including the progress information, input the third prompt sentence to the generative AI model, and obtain updated learning-plan information and feedback information corresponding to a remaining learning period, and transmit the updated learning-plan information and the feedback information to the learner-operated terminal for providing a personalized learning experience to the learner. This enables the server to implement a closed-loop, computer-implemented optimization process in which the server systematically controls the generative AI model through structured prompt sentences, automatically derives and refines degree-of-mastery information from stored data, and continuously regenerates and updates individualized learning plans based on real-time progress information, thereby improving computational efficiency, adaptability, and effectiveness of the learning support functions performed by the computer system.

The term “system” refers to a combination of one or more hardware devices and software modules that cooperate to execute processing for generating, updating, and providing learning plans, including at least a server and one or more learner-operated terminals.

The term “server” refers to an information processing apparatus comprising at least one processor, a memory, and a communication interface, configured to execute programs that perform data acquisition, data aggregation, interaction with a generative AI model, and transmission of learning-related information to a terminal via a communication network. The term “processor” refers to one or more hardware logic units, such as a central processing unit or a graphics processing unit, capable of executing instructions to perform arithmetic operations, logical operations, control operations, and data transfer operations that implement the functions described in the claims.

The term “storage unit” refers to one or more non-transitory computer-readable storage media, such as a semiconductor memory, a magnetic storage device, or an optical storage device, configured to store learning history information, performance information, progress information, and program instructions for execution by the processor.

The term “learner” refers to a human user who engages in study activities using the system, provides learning objectives and progress information, and receives learning-plan information and feedback information.

The term “learning terminal” refers to an electronic device operated by a learner, such as a personal computer, a tablet device, or a smartphone, that includes at least a display, an input interface, and a communication function, and that is configured to send and receive data to and from the server.

The term “learning objective” refers to target information indicating a desired learning outcome for the learner, including at least one of a target score, a target proficiency level, a target completion of specific learning contents, or a target period for achieving such outcome. The term “learner identification information” refers to information, such as an identification code or an account identifier, that uniquely or quasi-uniquely distinguishes one learner from another within the system.

The term “learning history information” refers to stored data representing past learning activities of a learner, including at least information regarding studied topics, completed tasks, learning timestamps, and study durations.

The term “performance information” refers to data indicating learning results of a learner, including at least test scores, assignment scores, practice results, or similar quantitative or qualitative measures of achievement in one or more learning fields.

The term “subject-wise or unit-wise performance information” refers to performance information categorized by educational subject, topic, chapter, or other instructional unit, enabling analysis of performance at a finer-grained level than overall learner performance. The term “study-time information” refers to data representing durations or amounts of time that a learner has spent on learning activities, optionally associated with specific learning fields, subjects, units, or tasks.

The term “learning field” refers to a conceptual category of learning contents, such as a subject, topic, or subtopic, within which the learner's mastery, performance, and study time can be evaluated.

The term “degree-of-mastery information” refers to information derived from performance information and study-time information that indicates a learner's level of understanding or proficiency for each learning field.

The term “strong field” refers to a learning field in which the learner's degree-of-mastery information indicates relatively high proficiency or understanding compared to other learning fields.

The term “weak field” refers to a learning field in which the learner's degree-of-mastery information indicates relatively low proficiency or understanding compared to other learning fields.

The term “generative AI model” refers to an artificial intelligence model, implemented using machine learning or deep learning, that generates or transforms data, including natural language text, based on input data and internal parameters, and that is capable of processing prompt sentences and producing analysis-result information and learning-plan information. The term “prompt sentence” refers to a text-based input sequence provided to a generative AI model, the text-based input sequence including instructions, constraints, or contextual information that guide the operations and output of the generative AI model.

The term “first prompt sentence” refers to a prompt sentence generated by the server based on at least a learning objective and degree-of-mastery information, and configured to instruct the generative AI model to identify strong fields and weak fields among learning fields.

The term “second prompt sentence” refers to a prompt sentence generated by the server based on at least an analysis result and a learning objective, and configured to instruct the generative AI model to generate personalized learning-plan information including a learning period, allocation of study time, and learning contents for each learning field.

The term “third prompt sentence” refers to a prompt sentence generated by the server based on updated learning history information and updated performance information, including progress information, and configured to instruct the generative AI model to update or modify learning-plan information and to generate feedback information.

The term “analysis-result information” refers to output data from the generative AI model obtained in response to at least the first prompt sentence, the output data including identification of strong fields and weak fields and optionally including explanatory or structured analysis regarding the learner's performance.

The term “learning-plan information” refers to information generated by the generative AI model, or by the server using results of the generative AI model, that specifies at least a learning period, allocation of study time, and learning contents for each learning field, and that can be presented as a schedule or a list of learning tasks.

The term “personalized learning-plan information” refers to learning-plan information that is individually tailored to a specific learner based on the learner's learning objective, degree-of-mastery information, and learning history information, rather than being a generic or uniform plan.

The term “learning period” refers to a time interval designated for executing a learning plan, including at least a start time, an end time, or a duration.

The term “allocation of study time” refers to a distribution of available learning time across one or more learning fields, tasks, or days, as specified in learning-plan information. The term “learning contents” refers to instructional materials or activities, including at least topics to be studied, types of problems to be solved, review activities, or other educational actions to be performed by the learner.

The term “learning task” refers to a unit of learning activity derived from learning-plan information, including at least a specific learning content, an associated expected duration, and a scheduled day or session.

The term “progress information” refers to data indicating the status of execution of learning tasks by the learner, including at least achievement status, additional performance information obtained after task execution, and self-evaluation information provided by the learner.

The term “achievement status” refers to information indicating whether and to what extent a learning task has been completed, such as completion flags, partial completion degrees, or qualitative assessments of completion.

The term “self-evaluation information” refers to subjective assessments provided by the learner regarding understanding, confidence level, perceived difficulty, or satisfaction with respect to one or more learning fields or tasks.

The term “updated learning history information” refers to learning history information that has been augmented or modified to include newly acquired progress information and additional performance information.

The term “updated performance information” refers to performance information that incorporates newly obtained results of tests, assignments, or practice tasks executed after the generation of an initial learning plan.

The term “updated learning-plan information” refers to learning-plan information that has been revised by the generative AI model or by the server based on updated learning history information and updated performance information, including consideration of a remaining learning period.

The term “feedback information” refers to data presented to the learner that includes evaluations, recommendations, or guidance derived from analysis-result information and progress information, and that is intended to support improvement of learning behaviors or understanding.

The term “remaining learning period” refers to a portion of a previously defined learning period that has not yet elapsed at the time of updating the learning-plan information. The term “personalized learning experience” refers to a learning process in which learning plans, tasks, and feedback are dynamically adapted to an individual learner's objectives, mastery levels, and progress, as implemented by the system through interaction between the server, the generative AI model, and the learning terminal.

In one embodiment, a server cooperates with one or more terminals operated by users to implement a personalized learning support system using a generative AI model controlled by programmatically generated prompt sentences. The server includes at least one processor, a main memory, a non-transitory storage device, and a network interface. The server runs an operating system such as a Linux-based server operating system, a web server such as an HTTP server, an application framework such as a server-side scripting framework, a database management system such as a relational database, and a model-serving framework such as a deep learning inference runtime. The terminal is, for example, a smartphone, a tablet, or a personal computer including a display, an input device, and a communication interface, and runs a web browser or a native application that communicates with the server via a communication network.

The server stores, in the storage device, learner information including learner identification information, learning history information, performance information, and progress information. The server represents such information in specific data structures. For example, the server represents a learner record as a table row including fields such as learner_id, subject_code, unit_code, timestamp, score, time_spent, task_id, and self_evaluation_score. The server represents a learning plan as a structured record including fields such as plan_id, learner_id, day_index, session_index, learning_field_id, recommended_duration_minutes, and task_description. The server represents degree-of-mastery information as a set of numerical values per learning field, such as a mastery_score in a normalized continuous range (for example, 0.0 to 1.0), computed from aggregated performance and study-time information.

The server uses a generative AI model as a core analysis and generation component. In one embodiment, the server deploys a transformer-based neural network model having multiple encoder-decoder layers, self-attention mechanisms, and feed-forward sublayers. The server implements the model using a deep learning framework such as a tensor computation library executed on graphics processing units. The generative AI model is trained in advance on large-scale text corpora and further fine-tuned on domain-specific educational data, where input sequences consist of prompt sentences and structured feature descriptions, and output sequences consist of analysis summaries, classifications of strong and weak learning fields, and structured learning plan descriptions. The server configures the model with parameters such as the number of layers, hidden dimension size, number of attention heads, vocabulary size, and maximum sequence length, and stores trained weights as parameter matrices on the storage device.

The server performs training of the generative AI model, in one embodiment, by using supervised learning with a cross-entropy loss function over token sequences, and optionally uses reinforcement learning from human feedback to bias outputs toward pedagogically effective plans. The server updates model weights by applying gradient-based optimization, for example, stochastic gradient descent with adaptive learning rate methods, using batches of training samples. During training, the server performs data augmentation by paraphrasing prompt sentences, shuffling order of examples, and perturbing numeric parameters within allowable ranges to improve model robustness. By configuring the internal optimization process and parameter update mechanisms, the server improves the ability of the generative AI model to generalize from stored learner data to new learners.

The server receives learner inputs via the terminal. The user operates the terminal to input a learning objective and optionally self-description information such as preferred study time or perceived difficulties. The terminal captures this text through a graphical user interface and sends the text to the server via a network protocol. The server stores the input as learning objective information associated with the learner identification information. The user also uses the terminal to view generated learning plans, to mark tasks as completed, and to provide self-evaluation scores or comments on specific learning tasks.

The server aggregates and transforms raw learning history information into degree-of-mastery information using specific algorithms that improve computational efficiency and analysis precision. For example, the server computes, for each learning field, a weighted average of recent scores, where more recent scores receive higher weights than older scores, and combines this with a logarithmic transformation of cumulative study time to penalize low performance despite high time investment. The server then normalizes these values across learning fields to compute relative mastery scores and identifies outliers where mastery is significantly lower or higher than the learner's overall average. By precomputing such numerical features before passing information to the generative AI model, the server reduces input dimensionality and computation inside the model, thereby improving inference speed and reducing network traffic for model-serving requests.

The server generates prompt sentences as explicit, structured instructions to control the generative AI model. The server does not merely pass free-form user text but constructs prompt sentences that encode system-level rules, constraints, and evaluation criteria. For example, the server generates a first prompt sentence for identifying strong and weak learning fields, such as:
“You are an educational analysis assistant.

The following is this learner's past math performance and study-time data by topic:
Algebra: average score 78/100, total study time 5 hours
Geometry: average score 60/100, total study time 7 hours
Quadratic equations: average score 55/100, total study time 4 hours

Based on these data, identify:
Weak_areas: topics where mastery is below the learner's overall average and where additional practice is needed.
Strong_areas: topics where mastery is above the learner's overall average.

### Output:

Weak_areas: [ . . . ]
Strong_areas: [ . . . ]
Short explanation: . . . ”

The server encodes, within this prompt sentence, a particular rule: topics with low scores despite high study time should be prioritized as weak fields, which is a non-trivial rule beyond simple thresholding. The server thus directs the generative AI model to compute a classification that is consistent with this rule, rather than leaving the classification to arbitrary heuristics.

The server generates a second prompt sentence for instructing the generative AI model to generate a personalized learning plan. An example is:
“You are a learning coach.
The learner's goal is:
‘I want to score at least 90 points on the next math exam in two weeks.’

The analysis of the learner's mastery is:
Weak_areas: [‘geometry (angles, triangles)’, ‘quadratic equations’]
Strong_areas: [‘linear equations’]

The learner can study about 60 minutes per day.

Create a 14-day learning plan that:
Allocates more time to weak areas than to strong areas.
Limits total study time to about 60 minutes per day.
Includes specific daily tasks, such as ‘solve 10 geometry problems on angles’ or ‘review basic formulas of quadratic equations’.

Output the plan as:
Day 1: . . .
Day 2: . . .
. . .
Day 14: . . . ”

The server specifies, within the prompt sentence, constraints on total time per day, prioritization of weak fields, and granularity of tasks. The generative AI model internally performs sequence-to-sequence generation under these constraints, computing attention weights between tokens representing the constraints and tokens representing candidate tasks. By structuring the prompt in this way, the server enables the model to perform a constrained optimization over many possible task sequences, which would be technically difficult and time-consuming to perform manually or via simple rule engines.

The server generates a third prompt sentence for updating a learning plan based on progress information. An example is:
“You are a learning coach.

The learner had the following 14-day math study plan aiming for 90 points on the next exam. The learner has completed 7 days.

### New Data:

Practice geometry test: score 70/100 (previously 60/100)
Practice quadratic equations test: score 55/100 (no improvement)
The learner reports difficulty with word problems involving quadratic equations.

Update the plan for the remaining 7 days to:
Focus more on quadratic equation word problems.
Maintain a short daily review of geometry and linear equations.
Keep total study time to about 60 minutes per day.
   Output the updated plan for Day 8 to Day 14.”

The server thereby instructs the generative AI model to perform incremental updating rather than regenerating an entirely new plan, and to consider specific error patterns (for example, difficulties with word problems) as features. This causes the model to adjust internal attention patterns and output distributions to emphasize tasks that target these error patterns, improving the effectiveness of the updated plan compared to generic revisions.

The server structures the internal data pipeline and module configuration to improve computer technology in several ways. The server separates aggregation of raw learner data, generation of prompt sentences, and inference by the generative AI model into distinct modules. Each module operates on well-defined data structures, and the server exploits caching, incremental updates, and batched model inference. For example, the server caches degree-of-mastery vectors per learner and updates only fields affected by newly received performance data, instead of recomputing all mastery scores from scratch. The server also groups multiple prompt sentences from different learners into a batch and performs a single inference call to the generative AI model, thereby reducing overhead of context loading and improving throughput of the GPU-based model-serving infrastructure. These architectural choices reduce latency and network traffic between application logic and model server, improve resource utilization on the server, and allow the system to support more concurrent learners on the same hardware.

The server improves accuracy of plan generation by encoding evaluation criteria explicitly in the prompt sentences and by structuring numeric features. The server can, for example, map mastery scores into discrete bands (for example, “low,” “medium,” “high”) and include these labels along with raw numerical values in the prompt sentences. This dual representation helps the generative AI model to handle both approximate reasoning and precise comparisons, improving robustness of classification of weak and strong fields. The server also computes derived features such as “performance trend” (for example, improving, stable, declining) for each learning field, based on time-series analysis of scores, and injects these features into the prompt sentences. The model then uses these features, via attention mechanisms, to produce learning plans that allocate additional practice to declining topics or to topics that show insufficient improvement relative to time invested.

The server performs computations inside the generative AI model using a transformer architecture. The model receives tokenized prompt sentences, where tokens are converted into vector embeddings. The model processes these embeddings through stacked self-attention layers, each computing attention weights across all token positions based on dot products of query and key vectors, followed by normalization and weighted sums of value vectors. The model applies feed-forward neural networks to intermediate representations, with non-linear activation functions such as rectified linear units. The model outputs probability distributions over vocabulary tokens at each step and samples or decodes tokens using beam search or top-k sampling strategies. The model's internal parameters (weights and biases) are fixed at inference time, and the server controls the model's behavior primarily through structured prompt sentences, not by changing weights.

The server uses this architecture to achieve technical improvements over conventional rule-based or static recommendation systems. By leveraging multi-head attention, the model can simultaneously consider multiple aspects of the prompt sentence, such as time constraints, weak fields, strong fields, and evaluation criteria, and can synthesize them into a coherent daily schedule. The server thus offloads complex combinatorial planning, which would require significant computational effort and intricate algorithm design if implemented as a traditional optimization engine, onto the generative AI model, while still maintaining deterministic control through prompt design. This reduces the number of handcrafted rules and database queries required for each planning operation, thereby reducing server-side code complexity and execution time.

The server improves data management and reduces communication load by transmitting only compact representations of plans and progress information between the server and the terminal. The server, for example, transmits text-based task descriptions and a small number of numeric fields per task, rather than transmitting large sets of raw training data or internal model weights. The terminal displays these tasks to the user and collects only concise responses (for example, completion flags, short comments, single numeric self-evaluation scores). This design minimizes data volume per interaction, allowing the system to support frequent updates without saturating network bandwidth.

The terminal presents user interfaces optimized for interaction with the server-generated learning plans. The terminal displays daily tasks in chronological order, using graphical elements to indicate priority and remaining time. The user operates the terminal to mark tasks as completed, to input self-evaluation scores, and to provide additional comments on perceived difficulty or interest. The terminal may also locally compute simple statistics such as daily completion rates and then send summarized progress information to the server, reducing the total number of records sent and further decreasing communication load. The terminal can cache recent learning plans and feedback to permit temporary offline usage and synchronize changes with the server when connectivity is restored.

The user benefits from this architecture by receiving up-to-date, detailed learning plans and feedback that are computationally optimized by the server in near real time. The user does not manually design schedules or analyze past performance data; instead, the user provides high-level goals and feedback, and the server performs complex data aggregation, analysis, and plan generation using the generative AI model. The user sees changes in the learning plan as soon as new performance or progress information is entered, owing to the server's efficient computation and the generative AI model's ability to quickly adapt outputs based on updated prompt sentences.

In additional embodiments, the server may use different types of generative AI models, such as encoder-only models for classification of weak and strong fields, and encoder-decoder models for text generation of learning plans. The server may also vary the model's architectural parameters, such as layer count or hidden dimension size, to balance accuracy and latency for different deployment environments. The server may deploy separate models for different subjects or educational levels and may select among them based on learner identification information. The server may also implement fallback strategies, such as simplified rule-based planning, when the generative AI model is unavailable, and may log outputs of both approaches for later comparison and retraining.

The server can further incorporate model uncertainty estimates into plan generation. The server may inspect output probabilities of the generative AI model to detect low-confidence suggestions and may insert additional constraints into subsequent prompt sentences to force clarification. For example, when the model shows low confidence in allocating time between two weak fields, the server can generate a refined prompt that explicitly asks the model to compute a time split proportional to the relative difference in mastery scores. This iterative prompt refinement mechanism results in more stable and predictable plans and demonstrates that the system uses the generative AI model as a controlled computational engine rather than as a black-box replacement for human reasoning.

By structuring data, prompt sentences, and model interactions in the described manner, the server improves the functionality of the computer system itself. The system achieves faster plan generation due to reduced search space and efficient batching; higher accuracy of identifying weak and strong fields due to integrated numerical features and model fine-tuning; improved data management through normalized schemas and incremental aggregation; and lower communication load through compact data exchange and local caching on the terminal. The server thereby implements a specific, technical solution to the problem of generating and updating personalized learning plans at scale, using a generative AI model under programmatic control by structured prompt sentences, in a manner that goes beyond simple automation of human educational planning and that results in demonstrable improvements in computational efficiency and learning-support performance.

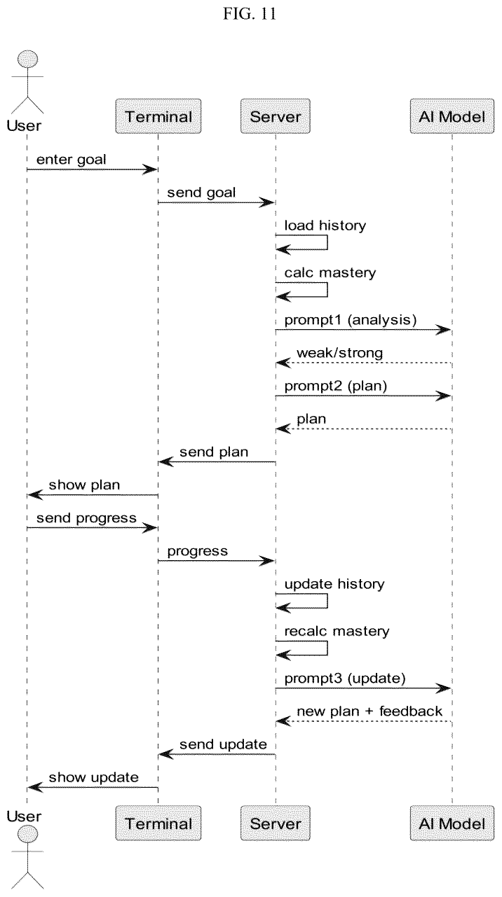

The following describes the processing flow using FIG. 11.

### Step 1

The user operates the terminal to input a learning objective and identification information. The terminal receives a text input such as “I want to score at least 90 points on the next math exam in two weeks” together with implicit or explicit identification information (for example, a login account). The terminal converts this input into an internal data structure including fields for learner_id, objective_text, and optional preference fields (such as available study time per day). The terminal then transmits this structured data to the server via a network protocol. The input to this step is raw user text and identification data; the output is a structured learning-objective request message sent from the terminal to the server.

### Step 2

The server receives the learning-objective request and stores it as part of learner information. The server accepts the incoming request, parses a message body, and validates fields such as learner_id and objective_text. The server then writes the learning objective into a learner information table, associating it with a record identified by learner_id. The server may normalize the text by lowercasing, removing extraneous whitespace, and storing a timestamp. The input to this step is the structured learning-objective request; the output is an updated learner record stored in the storage unit, including the new learning objective.

### Step 3

The server retrieves past learning history and performance data for the learner.

The server uses learner_id as a key to query a database table that stores learning history information and performance information. The server extracts rows containing subject_code, unit_code, past scores, timestamps, and past study durations. The server aggregates these rows by learning field (for example, topic-level grouping) using SQL group-by operations or equivalent data-processing functions. The input to this step is learner_id and database contents; the output is an in-memory collection of historical records grouped by learning field.

### Step 4

The server computes degree-of-mastery information from historical data.

The server processes the grouped records to calculate numerical mastery scores per learning field. For each field, the server computes a weighted average of past scores, applies a recency weight (for example, multiplying recent scores by a larger factor), combines this with a function of total study time (for example, a logarithmic transform of cumulative minutes), and normalizes the result to a fixed range such as 0.0 to 1.0. The server then stores the resulting mastery scores in a structure such as a list of (learning_field_id, mastery_score) pairs. The input to this step is aggregated historical performance and study-time data per field; the output is degree-of-mastery information for each learning field.

### Step 5

The server generates a first prompt sentence to identify strong and weak learning fields. The server takes the learning objective text, the degree-of-mastery scores, and summary statistics such as average mastery and standard deviation. The server converts mastery scores and study times into human-readable lines (for example, “Algebra: average score 78/100, total study time 5 hours”). The server concatenates these lines with an instruction template that defines weak and strong areas. The server thus produces a structured textual prompt such as:
“You are an educational analysis assistant.

The following is this learner's past math performance and study-time data by topic:
Algebra: average score 78/100, total study time 5 hours
Geometry: average score 60/100, total study time 7 hours
Quadratic equations: average score 55/100, total study time 4 hours

Based on these data, identify:
Weak_areas: topics where mastery is below the learner's overall average and where additional practice is needed.
Strong_areas: topics where mastery is above the learner's overall average.

### Output:

Weak_areas: [ . . . ]
Strong_areas: [ . . . ]
Short explanation: . . . ”

The input to this step is the learning objective and numerical mastery data; the output is a first prompt sentence ready to be sent to the generative AI model.

### Step 6

The server invokes the generative AI model with the first prompt sentence and receives analysis-result information.

The server tokenizes the first prompt sentence using a tokenizer associated with the generative AI model, converting text into a sequence of token IDs. The server submits these tokens to the model inference engine running on a processing unit such as a graphics processing unit. The generative AI model performs attention-based computations to generate output tokens representing identified weak_areas, strong_areas, and a short explanation. The server decodes the output tokens back to text and may parse the text to extract a list of weak fields and strong fields. The input to this step is the first prompt sentence and, optionally, additional numeric features; the output is analysis-result information including explicit lists of strong and weak learning fields.

### Step 7

The server generates a second prompt sentence to request a personalized learning plan. The server combines the learning objective, the weak_areas and strong_areas from the analysis result, and any learner preferences such as daily available study time. The server then fills an instruction template that specifies plan-generation constraints. The server constructs text such as:
“You are a learning coach.

The learner's goal is:
‘I want to score at least 90 points on the next math exam in two weeks.’

The analysis of the learner's mastery is:
Weak_areas: [‘geometry (angles, triangles)’, ‘quadratic equations’]
Strong_areas: [‘linear equations’]

The learner can study about 60 minutes per day.

Create a 14-day learning plan that:
Allocates more time to weak areas than to strong areas.
Limits total study time to about 60 minutes per day.
Includes specific daily tasks, such as ‘solve 10 geometry problems on angles’ or ‘review basic formulas of quadratic equations’.

Output the plan as:
Day 1: . . .
Day 2: . . .
. . .
Day 14: . . . ”

The input to this step is the analysis-result information and learner objectives/preferences; the output is a second prompt sentence instructing the generative AI model to generate a learning plan.

### Step 8

The server invokes the generative AI model with the second prompt sentence and generates learning-plan information.

The server tokenizes the second prompt sentence and sends the tokens to the generative AI model. Inside the model, the attention mechanisms relate constraint tokens (for example, “60 minutes per day”) to task tokens, producing an output sequence that enumerates Day 1 to Day N with recommended tasks and time allocations. The server decodes the output tokens into text, then parses the text to extract per-day entries, splitting by lines beginning with “Day 1:”, “Day 2:”, and so on. The server converts each entry into a structured record with fields for day_index, learning_field references, recommended_duration minutes, and textual task_description. The input to this step is the second prompt sentence; the output is structured learning-plan information for the specified period.

### Step 9

The server stores the generated learning plan and transmits it to the terminal. The server assigns a plan_id and inserts each task record into a learning plan table associated with the learner_id. The server then serializes the plan into a format suitable for communication and transmits it to the terminal. The server may include metadata such as generation timestamp and source model version. The input to this step is the structured learning-plan information; the output is a persistent plan stored on the server and a corresponding plan message sent to the terminal.

### Step 10

The terminal receives and displays the learning plan to the user.

The terminal parses the received plan message and converts each task record into user-interface elements such as list items grouped by day. The terminal calculates, for each day, total recommended study time and shows visual indicators such as progress bars. The user views the schedule and can tap or click tasks to see detailed descriptions. The input to this step is the transmitted learning-plan message; the output is a rendered user interface displaying daily learning tasks.

### Step 11

The user executes learning tasks and inputs progress and self-evaluation information.

The user follows the displayed plan, performs the suggested tasks, and operates the terminal to indicate completion status (for example, “completed” or “partially completed”). The user may also input new performance data such as quiz scores and may enter self-evaluation text or rating values describing understanding or difficulty. The terminal aggregates these inputs as progress records, each including task_id, completion_flag, optional new score, and self_evaluation_score. The input to this step is the learning-plan display and user interactions; the output is structured progress information prepared by the terminal.

### Step 12

The terminal transmits progress information to the server.

The terminal periodically or on-demand sends accumulated progress records to the server in batches. The terminal may compress multiple task updates into a single message to reduce network overhead. The input to this step is locally stored progress records; the output is a progress-information message sent from the terminal to the server.

### Step 13

The server updates learning history and performance data with the received progress information.

The server receives the progress-information message, parses task_id, completion_flag, any new scores, and self-evaluation values, and writes these into the learning history and performance tables. The server sets new timestamps, updates cumulative study time, and may compute per-task or per-field completion ratios. The input to this step is the progress information; the output is updated learning history information and updated performance information stored in the server's storage unit.

### Step 14

The server recomputes degree-of-mastery information using updated data.

The server identifies affected learning fields based on task_ids contained in the progress records. For those fields, the server retrieves updated scores and study-time data, recomputes weighted averages, trends, and cumulative times, and recalculates mastery_score values. The server updates the degree-of-mastery records accordingly. The input to this step is updated learning history and performance data; the output is a refreshed set of mastery scores reflecting the learner's most recent performance.

### Step 15

The server generates a third prompt sentence to update the existing learning plan.

The server determines the remaining learning period (for example, remaining days until the exam) and collects summary statistics for weak and strong fields after the update. The server then constructs a prompt sentence such as:
“You are a learning coach.

The learner had a 14-day math study plan aiming for 90 points on the next exam.

The learner has completed 7 days.

### New Data:

Practice geometry test: score 70/100 (previously 60/100)
Practice quadratic equations test: score 55/100 (no improvement)
The learner reports difficulty with word problems involving quadratic equations.

Update the plan for the remaining 7 days to:
Focus more on quadratic equation word problems.
Maintain a short daily review of geometry and linear equations.
Keep total study time to about 60 minutes per day.
   Output the updated plan for Day 8 to Day 14.”

The input to this step is updated mastery information, progress summaries, and the original plan structure; the output is a third prompt sentence that encodes constraints for revising the remaining part of the plan.

### Step 16

The server invokes the generative AI model with the third prompt sentence and obtains updated learning-plan information and feedback.

The server tokenizes the third prompt sentence and submits it to the generative AI model. The model processes the sequence, taking into account new performance details and remaining days, and generates an output sequence describing updated tasks for the remaining period, as well as explanatory feedback text (for example, “You should practice more quadratic equation word problems because your score did not improve”). The server decodes this output, parses the updated day-by-day tasks, and extracts a separate feedback message. The input to this step is the third prompt sentence; the output is updated learning-plan information for the remaining period and feedback information.

### Step 17

The server stores the updated plan and feedback and sends them to the terminal. The server modifies the existing plan entries for the remaining days or creates new entries, tagging them with an updated plan_id or version number. The server logs the feedback text in a feedback table associated with learner_id and timestamp. The server then transmits a message to the terminal containing the updated tasks for the remaining days and the feedback description. The input to this step is the updated learning-plan information and feedback; the output is a stored revised plan and a message delivered to the terminal.

### Step 18

The terminal displays the updated learning plan and feedback to the user.

The terminal receives the updated plan message, compares it with the existing displayed schedule, and replaces or annotates upcoming tasks accordingly. The terminal shows feedback text in a dedicated section (for example, a “coach comments” area) and may highlight changed tasks visually to draw the user's attention. The user sees how the future schedule has been altered and can adjust study behavior accordingly. The input to this step is the updated learning-plan and feedback message; the output is an updated user interface showing revised tasks and explanatory feedback.

### Step 19

The user continues the learning cycle based on the updated plan.

The user follows the revised daily tasks, again using the terminal to report completion, new scores, and self-evaluations. The user gains insight from the feedback about which areas need additional work and which topics require only light review. The input to this step is the displayed updated plan and feedback; the output is further progress information, which the terminal collects and sends back to the server, thereby closing the loop and enabling ongoing refinement of learning plans.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems generally rely on static rule-based recommendation engines or simple scoring logic to present learning content to users. Such systems typically map user profile attributes and past scores to pre-authored learning paths stored in a database. As a consequence, the systems often fail to adapt in a granular and timely manner to heterogeneous learner states, including differences in learning goals, topic-level mastery, available study time, and fluctuating motivation. This leads to suboptimal allocation of computational and content resources, and prevents the system from effectively maximizing learning outcomes.

In particular, known systems usually do not employ a unified, machine-readable representation that ties together (i) detailed learner status information, (ii) temporal scheduling constraints, and (iii) a large and diverse corpus of learning resources, in a way that can be dynamically processed and regenerated by a generative AI model. Existing architectures often treat AI-based content generation, content retrieval, and scheduling as separate components, resulting in fragmented data flows and high integration overhead. This fragmentation degrades system performance, increases latency, and makes it difficult to consistently generate coherent, personalized plans across multiple update cycles. Furthermore, in many existing systems, interaction with a generative AI model, when present, is limited to one-shot content generation with ad hoc prompts crafted manually by application code. The prompts are not systematically derived from structured learner data, progress metrics, or emotion-related signals. As a result, the computational capabilities of the generative AI model are underutilized, and the system cannot robustly adjust learning plans or feedback in response to fine-grained changes in learner behavior. This lack of structured prompt generation also hampers reproducibility, traceability, and optimization of the underlying computer processes.

Additionally, conventional systems rarely integrate emotion-related analysis in a closed feedback loop that programmatically influences both the prompt generation pipeline and the downstream selection of learning resources. Emotion detection, if present, is often treated as an auxiliary user-interface feature, rather than a core input to the computational logic that drives plan generation, content retrieval, and feedback synthesis. Consequently, the system cannot optimize computational and content decisions in view of the learner's estimated emotional state, which leads to inefficient use of processing resources and diminished learning effectiveness.

Accordingly, there is a need for an improved computer-centric technique that (i) programmatically transforms heterogeneous learner data, historical performance data, and emotion-related data into structured representations, (ii) generates and manages prompt sentences in a systematic manner for a generative AI model, (iii) converts natural-language outputs from the generative AI model into structured learning plan data consumable by search and scheduling components, and (iv) iteratively updates learning plans and feedback with low latency and high consistency. Such a technique should improve the operation of the computer system itself by introducing an architecture that efficiently couples data acquisition, structured plan representation, generative AI interaction, database retrieval, and emotion-aware optimization in a single, integrated processing pipeline.

The specific processing by the specific processing unit 290 of the data processing device 12 in Application Example 1 is realized by the following means.

The present invention provides a server comprising a processor and a memory storing instructions that, when executed by the processor, cause the server to acquire learner information including goal information and ability information, to normalize and structure the learner information into learning requirement data, to aggregate historical learning data including past performance data from a storage system, to generate prompt sentences in a natural language based on the learning requirement data and the historical learning data, the prompt sentences describing machine-readable conditions for learning content, learning periods, and learning allocations, to construct generation instruction data including the prompt sentences, and to supply the generation instruction data as input data to a generative AI model implemented on a computing platform. This enables the server to systematically drive the generative AI model by well-structured prompt sentences derived from internal data representations, thereby improving the consistency and efficiency of natural-language plan generation within the computer system.

The present invention provides a server comprising instructions to obtain, from the generative AI model, a learning plan text generated in response to a particular prompt sentence, to parse the learning plan text using text-processing logic into structured learning plan data including at least time slots, learning target domains, learning durations, and learning content types, and to validate and, when necessary, automatically adjust the structured learning plan data to conform to resource and time constraints maintained by the server. This enables the server to convert unstructured natural-language outputs from the generative AI model into a deterministic internal data structure that can be processed by scheduling and retrieval components, enhancing the reliability and machine-interpretability of AI-generated plans. The present invention provides a server comprising instructions to access a learning resource database storing metadata of multiple learning resources, to execute search queries against the learning resource database based on the structured learning plan data including target domains, difficulty levels, and learning durations, to rank and select specific learning resources corresponding to individual learning units in the structured learning plan data, and to generate a personalized learning resource list linked to the structured learning plan data. This enables the server to automatically transform abstract plan elements into concrete resource assignments through database operations, thereby optimizing content retrieval and reducing manual curation overhead within the computer environment.

The present invention provides a server comprising instructions to generate delivery data encapsulating the structured learning plan data and the personalized learning resource list, to transmit the delivery data to a terminal device via a communication interface, to receive learning progress data from the terminal device, and to compute learning status analysis data including at least domain-specific achievement indices and progress indices based on the learning progress data. This enables the server to maintain an up-to-date, machine-readable model of learner status that can be fed back into the prompt generation and plan adjustment pipeline, improving the responsiveness and adaptability of the computer-implemented learning system.

The present invention provides a server comprising instructions to generate, by using the learning status analysis data, prompt sentences that instruct the generative AI model to produce feedback texts and updated learning plan texts tailored to the current learner status, to send generation instruction data including such prompt sentences to the generative AI model, to receive the feedback texts and the updated learning plan texts, and to convert the updated learning plan texts into updated structured learning plan data, followed by re-querying the learning resource database to form updated learning resource lists. This enables the server to implement an iterative, closed-loop control over the generative AI model, where each cycle of progress measurement leads to refined prompts, new AI-generated plans, and updated database retrieval, thereby improving the overall computational workflow and reducing system-level latency for plan adaptation.

The present invention provides a server comprising instructions to acquire emotion-related data including behavior information and response information from the terminal device, to generate emotion analysis data by estimating an emotion state of the learner using computational emotion analysis logic, and to generate, based on the emotion analysis data, additional prompt sentences that direct the generative AI model to optimize learning plans, learning resource selections, and feedback content in view of the estimated emotion state. This enables the server to integrate emotion-aware computation into the same structured prompt and plan pipeline, allowing the computer system to adjust AI generation parameters, content difficulty, and scheduling according to inferred emotional conditions, and thereby improving the effectiveness and robustness of the machine-driven personalization process. The present invention provides a server comprising instructions to orchestrate the above-described processes in a unified architecture, such that learner data ingestion, structured representation, prompt sentence generation, generative AI invocation, natural-language parsing, database retrieval, progress analysis, and emotion-aware optimization are performed in a coordinated and repeatable manner under program control. This enables the computer system to operate as an integrated, adaptive learning platform that improves utilization of computational resources, enhances the quality and traceability of interactions with the generative AI model, and yields dynamically updated, personalized learning experiences that are difficult to achieve with conventional, non-integrated systems.

The term “learner” refers to a human user who interacts with the system in order to acquire knowledge or skills, and whose goals, abilities, progress, and emotion-related states are processed by the server.

The term “learner information” refers to data associated with a learner, including at least goal information, ability information, and optionally attribute information, past performance data, and available study time, which are used by the server to generate learning requirement data. The term “goal information” refers to data indicating one or more target outcomes desired by a learner, such as target scores, proficiency levels, or completion of particular topics within a specified time period.

The term “ability information” refers to data indicating a learner's current level of knowledge, skill, or understanding in one or more domains, which may be derived from test scores, past performance records, or self-assessments.

The term “learning requirement data” refers to structured data generated by the server based on learner information and historical learning data, the structured data indicating learning tasks, target domains, and available time to be considered in planning.

The term “historical learning data” refers to data accumulated over time for a learner, including past performance data, completion records, interaction logs, and previous learning plans, which are used to inform generation of new plans and feedback.

The term “past performance data” refers to quantitative or qualitative records of a learner's previous learning results, such as scores, accuracy rates, error types, or completion statuses for particular tasks or topics.

The term “prompt sentence” refers to a natural-language sentence or sequence of sentences generated by the server, which encodes instructions, constraints, and context for a generative AI model, and which forms part of generation instruction data.

The term “generation instruction data” refers to data provided as input to a generative AI model, including at least one prompt sentence and optionally additional structured parameters, that collectively specify what type of output the model should generate.

The term “generative AI model” refers to a machine-implemented model, such as a neural network-based language model, configured to generate new text or other content in response to input data including a prompt sentence.

The term “learning plan text” refers to natural-language text generated by the generative AI model in response to a prompt sentence, the text describing a proposed learning plan including at least tasks, topics, and time allocations.

The term “structured learning plan data” refers to a machine-readable representation derived by parsing a learning plan text, including explicit fields such as time slots, learning target domains, learning durations, and learning content types.

The term “learning target domain” refers to a subject area or topic category, such as a particular discipline, subfield, or concept cluster, which is specified as a target for learning activities in structured learning plan data.

The term “learning content type” refers to a classification of a learning resource, such as video, practice problem set, textual explanation, assessment, or review material, used to characterize tasks in a learning plan.

The term “learning resource database” refers to a storage system that holds learning resource metadata and optionally content items, and that can be queried by the server to retrieve resources matching specified conditions.

The term “learning resource metadata” refers to descriptive information associated with a learning resource, such as subject, topic, difficulty level, estimated duration, format type, and identifiers, used to index and retrieve the resource.

The term “learning resource list” refers to a set of selected learning resources, represented in a structured form and associated with elements of a structured learning plan, which the server prepares for presentation to a learner.

The term “personalized learning resource list” refers to a learning resource list that has been selected by the server based on learner-specific data, including goals, abilities, historical learning data, and structured learning plan data.

The term “delivery data” refers to data generated by the server for transmission to a terminal device, the data encapsulating at least structured learning plan data and an associated learning resource list for presentation to a learner.

The term “terminal device” refers to an electronic device operated by a learner, such as a computing device, communication device, or display device, which receives delivery data from the server and returns learning progress data.

The term “learning progress data” refers to data indicating how a learner has executed assigned tasks, including at least completion statuses, usage times, scores, and timestamps, obtained from interactions with resources on a terminal device.

The term “learning status analysis data” refers to processed data generated by the server from learning progress data, including at least domain-specific achievement indices and progress indices representing current learning status.

The term “domain-specific achievement index” refers to a numerical or categorical indicator of a learner's performance level in a particular learning target domain, derived from past performance and progress data.

The term “progress index” refers to a numerical or categorical indicator of the extent to which a learner has followed or completed a prescribed learning plan, including measures of completion ratio, delay, or advancement.

The term “feedback text” refers to natural-language text generated by the generative AI model in response to a prompt sentence, the text describing evaluations, advice, or guidance tailored to a learner's current learning status.

The term “updated learning plan text” refers to natural-language text generated by the generative AI model that describes modifications or refinements to a previous learning plan based on updated data including learning status analysis data.

The term “updated structured learning plan data” refers to structured learning plan data derived by parsing an updated learning plan text and used by the server to reconfigure scheduled tasks and associated resources.

The term “emotion-related data” refers to data obtained from learner interactions, including behavior information, response information, or sensor outputs, which may be used by the server to infer an emotion state of the learner.

The term “behavior information” refers to observable interaction patterns of a learner with a terminal device or learning resources, such as input timing, navigation patterns, response speeds, and interruption frequencies.

The term “response information” refers to explicit or implicit responses from a learner, such as answers to questions, self-reported feelings, or reaction ratings, which may signal an underlying emotion state.

The term “emotion analysis data” refers to processed data generated by the server by applying emotion estimation logic to emotion-related data, the processed data representing an inferred emotion state of the learner.

The term “emotion state” refers to an estimated psychological condition of a learner, such as stress level, engagement level, frustration, or confidence, derived from emotion-related data and used to influence plan and content optimization.

The term “communication path” refers to one or more communication channels or networks used to transfer data between the server and a terminal device, such as wired or wireless communication links.

The term “storage system” refers to one or more physical or virtual storage resources, such as databases or file storage, used by the server to store learner information, historical learning data, and learning resource metadata.

The term “text-processing logic” refers to computational procedures executed by the server to analyze, parse, and transform natural-language text, including tokenization, segmentation, and pattern extraction, into structured data.

The term “scheduling and retrieval components” refers to software components executed by the server that allocate tasks over time and retrieve appropriate resources from a learning resource database based on structured learning plan data.

The term “integrated processing pipeline” refers to an organized sequence of computational steps executed by the server, where acquisition of data, generation of prompt sentences, invocation of a generative AI model, parsing of outputs, and retrieval of resources are performed in a coordinated manner under program control.

The server, the terminal, and the user each cooperate to implement the embodiments described below. The embodiments are presented as examples and do not limit the scope of the claims.

The server includes at least one processor, a memory, a storage system, and a communication interface. The server may be realized on general-purpose computing hardware such as a rack-mounted computer with a multi-core CPU and, optionally, a graphics processing unit. The server executes an operating system and application software including an application framework, a machine learning framework, and database management software. The server uses the application framework to implement network-accessible services and uses the machine learning framework to execute a generative AI model. The storage system stores learner information, historical learning data, learning resource metadata, and intermediate results such as structured learning plan data and learning status analysis data.

The terminal includes an input interface, a display interface, a communication module, and a local memory. The terminal may be realized as a smartphone, tablet, or personal computer executing a web browser or a native learning application. The terminal provides graphical user interfaces that allow the user to input learning goals and respond to feedback, and also render structured learning plans and associated content received from the server. The terminal communicates with the server using network protocols over wired or wireless networks. The user operates the terminal to input learner information. The user may provide, for example, a target score for a particular examination, a target level of language proficiency, or a desired completion time for a course. The user may also input self-assessments of ability, such as “weak in differentiation” or “confident in basic algebra,” and may register available study time per day or per week. The terminal converts the user's input into structured data and transmits the data to the server.

The server stores incoming learner information in the storage system in association with a learner identifier. The server organizes data in tables or collections, for example, a learner table storing static attributes, a goal table storing time-stamped goal records, a performance table storing scores and completion metrics, and a resource table storing learning resource metadata. The server uses a data access layer to retrieve and update these records in a transactional and consistent manner.

The server generates learning requirement data by normalizing and structuring learner information and historical learning data. The server may convert raw scores to normalized values on a common scale, such as mapping scores to the range of 0 to 1, and may compute per-topic statistics such as an average correct ratio and a variance of scores. The server may encode categorical information, such as subject area and topic codes, into internal identifiers, and may construct tensor or vector representations that summarize the learner's state across multiple topics. The server may also enforce constraints, such as maximum daily study time or deadlines, and represent these constraints explicitly in the learning requirement data. The server generates prompt sentences in natural language based on the learning requirement data and historical learning data. The server uses predefined templates and rule-based text assembly logic to construct highly structured prompt sentences that explicitly express machine-readable conditions and constraints to the generative AI model. The server may, for example, generate a prompt sentence of the following form:

“The user's goal is to score at least 80 points on the mathematics exam in four weeks. The user's past average score is 60 points, with 50 points in differentiation and 70 points in algebra. The user can study 1.5 hours per day. Based on this data, propose a detailed weekly learning plan, focusing on differentiation and including specific topics, estimated study time per topic, and types of materials (video lectures, practice problems, and review sessions).” The server may generate another prompt sentence when the learner's progress and emotion state are updated, for example:

“The user's goal is to achieve at least 80 points on the high-school mathematics test in one month. The user's past results show 50% average accuracy in differentiation and 75% in algebra. The user has completed 60% of the planned tasks and scores around 55% on differentiation quizzes. The user reports feeling frustrated about differentiation. Generate a revised two-week learning schedule with shorter but more frequent differentiation exercises, additional review of basic rules, and motivational feedback messages.”

The server uses a generative AI model executed by the machine learning framework to process the prompt sentences. The generative AI model may be implemented as a sequence-to-sequence neural network or a transformer-based language model composed of multiple layers of self-attention and feed-forward sub-layers. The server maintains the model parameters as learned weights stored in the storage system and loaded into memory at runtime. The server may use embeddings to convert tokens of a prompt sentence into high-dimensional numerical vectors, may apply position encodings to preserve sequence order, and may propagate these vectors through attention layers that compute weighted combinations of tokens according to learned attention matrices.

The server may train or fine-tune the generative AI model using a supervised learning procedure. The server may define a loss function that measures the cross-entropy between predicted token distributions and ground truth tokens in training data comprising example learning plans and feedback texts. The server may use gradient-based optimization, such as stochastic gradient descent or an adaptive optimizer, to update the model's weight matrices. The server may also employ regularization techniques, such as dropout in attention and feed-forward layers, to prevent overfitting, and may perform data augmentation by varying or paraphrasing training prompts to increase robustness.

The server configures generation parameters of the generative AI model, such as maximum output token length, temperature, and sampling scheme. The server may fix these parameters per use case or adapt them based on learner attributes or emotion analysis data, so that, for example, a more detailed plan is generated for learners with complex goals, or more concise feedback is provided for learners who show low engagement.

The server receives natural-language outputs from the generative AI model, such as learning plan texts and feedback texts. The server then executes text-processing logic to convert these unstructured texts into structured representations. The server may segment the learning plan text into units corresponding to days or weeks, detect labels such as “Week 1,” “Day 3,” or

“Topic: Differentiation,” and extract numerical indications of durations, such as “30 minutes” or “1 hour.” The server may apply rule-based parsers or statistical sequence labeling models that map text tokens to structured labels. The server may output structured learning plan data whose elements each specify a scheduled date or relative day index, a learning target domain, a duration value, and a learning content type.

The server validates the structured learning plan data with respect to system constraints. The server may sum total daily durations to check that the total does not exceed the learner's indicated available time, may check that the plan covers all required topics for the goal, and may detect overlapping or missing time slots. The server may, if necessary, adjust durations by rescaling or reassigning tasks to different days, while preserving the sequence pattern and relative emphasis specified by the generative AI model. This validation and adjustment step improves reliability and prevents infeasible plans from being presented to the user.

The server uses the structured learning plan data to query a learning resource database. The server may store learning resources such as video files, interactive quizzes, documents, and summary notes along with metadata fields detailing subject, topic, subtopic, difficulty, estimated time to complete, prerequisites, and resource format. The server may construct search queries that match the topic and difficulty level specified in the structured learning plan data and limit candidate resources to those whose estimated completion time approximates the required duration. The server may apply ranking algorithms that weight resource relevance, learner's historical engagement with similar resources, and resource quality metrics. The server then selects one or more resources for each learning unit and forms a personalized learning resource list.

The server generates delivery data that bundle the structured learning plan data and the personalized learning resource list and transmits this data to the terminal. The terminal receives the delivery data and renders visual representations such as calendar views, task lists, and content cards. The terminal may use user interface libraries to display progress bars, color-coded difficulty indicators, or notification prompts for upcoming tasks. The terminal may provide control elements that allow the user to start a particular learning activity and to indicate task completion.

The user executes learning activities via the terminal. The user may watch a video lecture, answer questions in a practice problem set, or read textual documents. The terminal records user interactions, such as the time when a video is started and stopped, which questions are answered correctly or incorrectly, and whether a task is completed or skipped. The terminal aggregates these interaction events into learning progress data and transmits the progress data to the server at determined intervals or upon completion of tasks.

The server receives learning progress data and computes learning status analysis data. The server may calculate domain-specific achievement indices by aggregating scores and completion data for each learning target domain, and may calculate progress indices that express the ratio of completed tasks to scheduled tasks, the amount of delay or advance relative to the plan, and trends in performance improvement or decline. The server stores the learning status analysis data in the storage system and may maintain time series of these indicators to support temporal analysis.

The server acquires emotion-related data from the terminal. The terminal may measure behavior information, such as rapid switching between resources, frequent pausing of videos, or extended inactivity, and may accept response information, such as explicit self-reports of satisfaction or frustration. The server processes emotion-related data using emotion analysis logic, which may include statistical models or neural networks trained to map behavioral features and response patterns to discrete emotion states or continuous emotion scores. The server may, for example, derive an engagement score, a frustration score, and a confidence score per learning session. The server stores the emotion analysis data in the storage system. The server generates additional prompt sentences for the generative AI model based on both learning status analysis data and emotion analysis data. For instance, the server may generate a prompt sentence:

“The user's goal is to score at least 80 points on the math exam. The user has completed 60% of the planned tasks, with an average score of 55% on differentiation quizzes and 80% on algebra quizzes. Behavior analysis indicates frequent pauses and rapid skipping on differentiation resources, suggesting frustration. The exam is in two weeks. Provide constructive feedback on the user's progress, suggest motivational messages, and propose specific adjustments to reduce cognitive load while maintaining sufficient practice on differentiation.”

The server sends these prompt sentences to the generative AI model and obtains feedback texts and updated learning plan texts. The server converts updated learning plan texts to updated structured learning plan data in a similar manner as described above and re-queries the learning resource database to obtain updated learning resource lists. The server then delivers the updated plan and feedback to the terminal. The terminal displays the feedback messages and the revised plan to the user, such as recommending more frequent breaks, shorter tasks, or easier introductory materials to rebuild confidence.

The server improves computer technology in several ways. The server introduces a specific, non-conventional data flow where learner information, historical learning data, and emotion-related data are transformed into structured learning requirement data and further into structured learning plan data via constrained, template-based prompt sentences and deterministic parsing rules. This architecture differs from generic one-shot content generation because it effectively treats prompt sentences and AI outputs as intermediate representations in a larger computational pipeline. The server thereby reduces ambiguity in AI interaction, improves reproducibility of outputs, and enables systematic logging and optimization of AI behavior.

The server also reduces processing latency and network load through selective regeneration of plan segments. Rather than re-generating a complete plan whenever new data arrive, the server may analyze learning status analysis data to identify only the impacted segments of a plan, such as tasks related to a particular topic. The server may then generate prompt sentences that request modifications for those segments only, reducing token lengths of both prompt and output and decreasing computational load on the generative AI model and communication overhead between the server and the model. This targeted regeneration improves real-time responsiveness and conserves computing resources.

The server achieves improved accuracy and robustness in personalization by combining rule-based validation and adjustment layers with the probabilistic outputs of the generative AI model. The server detects inconsistencies and constraints violations at the structured data level and applies domain-specific correction rules. This combined approach reduces the probability of unrealistic or unimplementable plans, which would otherwise require manual correction. The server thus enhances the effective reliability of AI-generated outputs in a fully automated manner.

The server also provides technical improvements in data management by storing structured learning plan data, learning status analysis data, and emotion analysis data in unified, indexed data structures. The server may maintain indexes keyed by learner identifier, domain, and time, allowing efficient retrieval of relevant records for prompt generation and analysis. The integration of emotion analysis data as first-class input to computational decisions (plan generation, resource selection, and feedback wording) establishes a feedback loop that is not typically present in conventional learning systems that merely log such information. This structured integration supports scalable computation over large numbers of learners without linear growth of manual configuration workload.

In alternative embodiments, the server may employ different model architectures, such as recurrent neural networks or hybrid models where a rule-based planner suggests initial schedules and the generative AI model produces textual explanations and refinements. The server may employ alternative emotion analysis techniques, including heuristic-based thresholds on interaction metrics, classical machine learning classifiers, or pre-trained neural models specialized in sentiment analysis. The server may vary the internal data structures, for example by representing structured learning plan data as graph structures that encode prerequisite relationships between topics, and may then adapt the prompt generation logic to include graph-based representations or summaries.

The terminal, in some embodiments, may perform certain pre-processing tasks to reduce network traffic and server load. For example, the terminal may locally aggregate high-frequency interaction events into summarized behavior features, such as average video watch ratio or average response time per quiz session, and may send only the summarized features to the server. This reduces the volume of transmitted data and allows the server to focus on higher-level analysis and plan adjustment.

The user benefits from this system because the server continuously refines learning plans and feedback based on detailed internal computations that would be infeasible for a human tutor to perform at scale or with such speed. However, the key technical contribution resides in the server's internal processing, including the dynamic generation and use of prompt sentences, the deterministic parsing and validation of generative AI outputs, the integration of emotion analysis into the computational loop, and the representation of complex learner states in structured data that drive efficient retrieval and scheduling operations. This specific combination and sequencing of computational steps improves the functioning of the computer system as a whole, resulting in faster, more accurate, and more resource-efficient personalization than conventional systems.

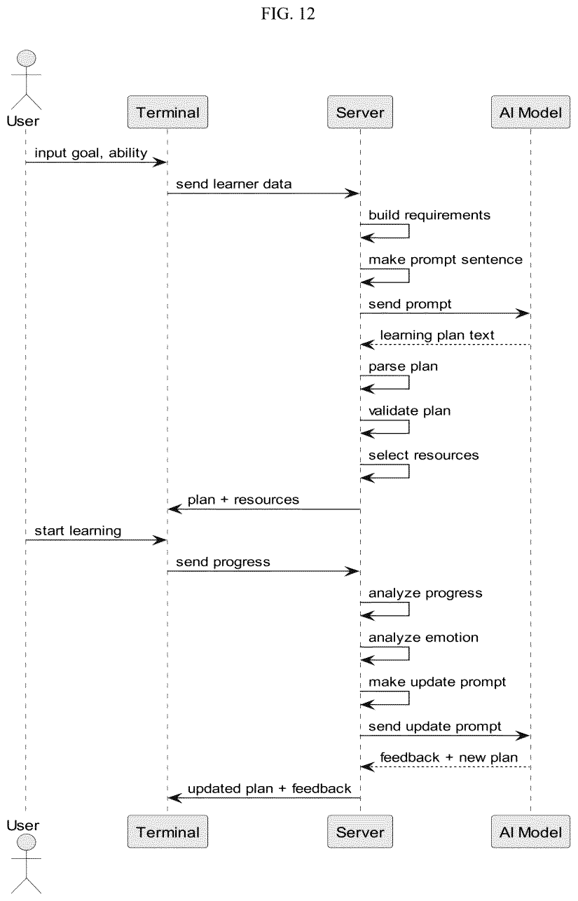

The following describes the processing flow using FIG. 12.

### Step 1

The terminal displays an input screen for learner information and goals.

The terminal receives, as input, user-entered data including learning goals (for example, target score and target date), self-assessed abilities, available study time, and optional remarks about weak topics.

The terminal validates the input by checking that numeric fields are within allowable ranges, that dates are in a valid format, and that mandatory fields are not empty.

The terminal converts the validated input into a structured internal representation, for example a key-value map with fields such as goal, subject, weak_topics, available_time_per_day, and target_date.

The terminal outputs a serialized data object containing the structured learner information and transmits this data object to the server via a network interface.

### Step 2

The server receives the learner information from the terminal.

The server takes, as input, the serialized learner information object and a learner identifier obtained from an authentication or session mechanism.

The server deserializes the object into in-memory data structures and checks consistency with existing records by querying stored learner profiles in a storage system.

The server writes new records or updates existing records in data tables for learner profiles, goals, and self-assessed abilities, using database operations to insert or update rows.

The server outputs updated persistent records in the storage system and an internal learner context object that aggregates current learner information and existing historical learning data.

### Step 3

The server generates learning requirement data from learner information and historical learning data.

The server receives, as input, the learner context object, including latest learner information and historical learning data such as past test scores and completion histories.

The server performs data processing by normalizing numeric scores to a common scale, encoding categorical values (such as subjects and topics) as internal identifiers, and computing summary statistics per topic (for example, average score, variance, and count of attempts).

The server constructs learning requirement data that explicitly list required topics, estimated difficulty per topic, required total study time, and constraints such as maximum daily study time and remaining days until the goal date.

The server outputs the learning requirement data as a structured data structure to be used for prompt sentence generation.

### Step 4

The server generates a prompt sentence for the generative AI model based on the learning requirement data.

The server receives, as input, the learning requirement data, including normalized scores, topic-level statistics, time constraints, and target performance.

The server selects a prompt template appropriate for the learner's goal type (for example, exam preparation, language acquisition, or course completion), and fills template slots with values from the learning requirement data.

The server performs string operations to assemble a coherent natural-language prompt sentence, for example:

“The user's goal is to score at least 80 points on the mathematics exam in four weeks. The user's past average score is 60 points, with 50 points in differentiation and 70 points in algebra. The user can study 1.5 hours per day. Based on this data, propose a detailed weekly learning plan, focusing on differentiation and including specific topics, estimated study time per topic, and types of materials (video lectures, practice problems, and review sessions).” The server outputs the constructed prompt sentence and a generation instruction object containing the prompt sentence and generation parameters for the generative AI model.

### Step 5

The server invokes the generative AI model to generate a learning plan text.

The server receives, as input, the generation instruction object including the prompt sentence and parameters such as maximum output length and temperature.

The server tokenizes the prompt sentence into tokens using a tokenizer compatible with the generative AI model and converts each token into an embedding vector.

The server inputs the sequence of embedding vectors into a neural network architecture, for example a transformer model with multiple self-attention layers, where the model performs matrix multiplications, attention weight calculations, non-linear activations, and normalization operations to compute a probability distribution over possible next tokens at each step.

The server executes an autoregressive generation process that iteratively samples or selects tokens according to the computed probability distributions until an end-of-sequence condition or length limit is reached.

The server decodes the generated tokens back into text to obtain a learning plan text in natural language.

The server outputs the learning plan text as the result of the generative AI model invocation.

### Step 6

The server converts the learning plan text into structured learning plan data.

The server receives, as input, the learning plan text generated by the generative AI model.

The server performs text-processing operations that segment the text into units corresponding to days and weeks, detect headings or cues such as “Week 1,” “Day 2,” or “Topic: Differentiation,” and identify durations expressed in phrases such as “30 minutes” or “1 hour.”

The server applies parsing rules and pattern-matching algorithms to map segments of text to fields including date or relative day index, learning target domain, duration, and learning content type (for example, video, practice, or review).

The server constructs structured learning plan data as a collection of learning tasks, each task being an object with explicit fields for schedule, domain, duration, and content type. The server outputs the structured learning plan data for validation and resource selection.

### Step 7

The server validates and, if needed, adjusts the structured learning plan data.

The server receives, as input, the structured learning plan data and the learning requirement data containing time constraints and required coverage.

The server performs data calculation to compute, for each day, the sum of scheduled durations and compares the sum with the learner's available time; the server also calculates coverage metrics such as whether all targeted topics appear in the learning plan and whether minimum durations per topic are satisfied.

The server detects violations, such as over-allocated daily time, missing critical topics, or inconsistent ordering, and applies rule-based adjustment algorithms to rescale durations or reassign tasks across days to satisfy constraints while preserving the relative emphasis suggested by the generative AI model.

The server outputs validated and possibly adjusted structured learning plan data that conform to constraints and can be executed feasibly by the learner.

### Step 8

The server selects concrete learning resources based on the structured learning plan data.

The server receives, as input, the validated structured learning plan data and access to a learning resource database storing learning resource metadata.

The server forms search queries for each learning task using task attributes such as target domain, desired difficulty, estimated duration, and content type, and issues these queries to the learning resource database.

The server obtains candidate learning resources as output from database queries and computes ranking scores for candidates using data calculation that consider factors such as topic match, difficulty match, estimated duration proximity, resource quality indicators, and learner's past engagement with similar resources.

The server selects top-ranked resources per learning task and constructs a personalized learning resource list that maps each task in the structured learning plan data to one or more specific resources with identifiers and access URLs.

The server outputs the personalized learning resource list for delivery to the terminal.

### Step 9

The server prepares delivery data and sends the plan and resources to the terminal.

The server receives, as input, the validated structured learning plan data and the personalized learning resource list.

The server serializes these data into a delivery data structure that includes schedule information, task descriptions, and references to learning resources, formatted for efficient transmission and rendering.

The server may compress the data, assign version identifiers, and sign or encrypt the payload for integrity and security.

The server transmits the delivery data through the communication interface to the terminal. The terminal receives the delivery data, deserializes the contents, and outputs a rendered user interface displaying the schedule, tasks, and interactions for launching each learning resource.

### Step 10

The user performs learning activities using the terminal.

The user receives, as input, the visual representation of the learning plan and the list of resources on the terminal display.

The user selects a particular task, such as “Watch 20-minute lecture on differentiation basics” or “Solve 10 practice problems on chain rule.”

The terminal, upon selection, launches an appropriate content viewer or player, such as a video player or quiz interface, and records interaction events such as start time, end time, responses, and navigation actions.

The terminal outputs aggregated interaction data as raw progress events for subsequent transmission to the server.

### Step 11

The terminal sends learning progress data to the server.

The terminal receives, as input, the raw progress events generated while the user interacts with learning resources.

The terminal performs local aggregation, for example calculating total watch time for a video, number of problems attempted, number of correct answers, and timestamps of activity, and encodes these metrics into learning progress data objects.

The terminal may batch multiple progress data objects and apply optional compression to reduce communication overhead.

The terminal transmits the learning progress data to the server via the communication module.

The server receives the learning progress data and outputs updated records stored in the storage system.

### Step 12

The server analyzes learning progress data to generate learning status analysis data.

The server receives, as input, the learning progress data including task completion flags, scores, and activity durations.

The server performs data calculation to compute domain-specific achievement indices, such as average quiz score per topic, and progress indices, such as completion ratio of scheduled tasks per day or week.

The server aggregates metrics over time, updates rolling averages and trends, and may detect patterns such as consistent underperformance on a given topic or repeated skipping of certain types of resources.

The server stores the computed learning status analysis data and outputs an updated learner status profile for use in subsequent prompt generation.

### Step 13

The server acquires and analyzes emotion-related data.

The server receives, as input, emotion-related data from the terminal, including behavior information such as frequent pausing, fast skipping, or prolonged inactivity, and response information such as self-reported satisfaction or difficulty levels.

The server extracts quantitative and categorical features from the emotion-related data, such as rates of interruption per session, average time to first pause, and patterns of rating selections.

The server applies emotion estimation algorithms, which may include statistical classifiers or neural networks trained on labeled data, to map these features to one or more emotion states such as engagement, frustration, or confidence, and computes emotion analysis data values. The server stores the emotion analysis data in association with the learner's recent activities and outputs updated emotion state indicators for use in adaptive prompt generation.

### Step 14

The server generates updated prompt sentences based on learning status analysis data and emotion analysis data.

The server receives, as input, the updated learner status profile including domain-specific achievement indices, progress indices, and emotion analysis data.

The server selects a feedback-oriented prompt template and fills it with dynamic values, generating a prompt sentence that instructs the generative AI model to produce both feedback text and an updated plan.

The server may, for example, generate the following prompt sentence:
“The user's goal is to score at least 80 points on the math exam. The user has completed 60% of the planned tasks, with an average score of 55% on differentiation quizzes and 80% on algebra quizzes. Behavior analysis indicates frequent pauses and rapid skipping on differentiation resources, suggesting frustration. The exam is in two weeks. Provide constructive feedback on the user's progress, suggest motivational messages, and propose specific adjustments to reduce cognitive load while maintaining sufficient practice on differentiation.”

The server outputs this updated prompt sentence and associated generation instruction data for input to the generative AI model.

### Step 15

The server obtains feedback text and updated learning plan text from the generative AI model and updates the plan.

The server receives, as input, the generation instruction data containing the updated prompt sentence and generation parameters.

The server processes the prompt sentence through the generative AI model, which performs internal neural computations similar to Step 5 to generate textual output that includes feedback messages and suggested modifications to the existing plan.

The server parses the updated learning plan text into updated structured learning plan data using the same or extended parsing rules as before, and extracts feedback text as a separate component.

The server revalidates the updated structured learning plan data against constraints, adjusts it if necessary, and re-queries the learning resource database to select updated resources that match the new plan.

The server outputs updated delivery data including the feedback text, the updated structured learning plan data, and the updated personalized learning resource list, and transmits this data to the terminal for presentation to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning support systems that employ machine learning or rule-based recommendation engines typically focus on static or coarse-grained parameters, such as a learner's grade level or a preassigned curriculum. These systems generally generate recommendations based on limited snapshots of performance or on manually defined rules, and do not fully exploit continuously updated, fine-grained learning activity data and user feedback. As a result, the underlying computer system fails to dynamically adapt its internal data representations, model inputs, and control logic to reflect the learner's evolving state, which leads to suboptimal utilization of computational resources and reduced accuracy of personalization.

Furthermore, known systems that interact with artificial intelligence models often pass simple, fixed-format inputs to such models, without systematically integrating heterogeneous data sources such as detailed learning histories, real-time feedback on understanding and difficulty, and emotion-related signals. In such architectures, prompt sentences to a generative AI model are usually handcrafted or static, and the server does not maintain a dedicated mechanism to transform multi-dimensional learner state into structured feature data and context-rich prompts. This limits the ability of the generative AI model to compute relevant outputs, and constrains the adaptability of the system to changes in learner behavior. From a computer technology perspective, the data processing pipeline lacks an integrated feature-generation layer and dynamic prompt control logic, and thus does not fully improve the functioning of the computer system itself.

Additionally, in many existing platforms, different types of learner data—activity logs, performance scores, and emotion-related measurements—are stored and processed in separate subsystems, with minimal coordination. The server does not maintain a unified representation of learner state that can be reused and updated across multiple model calls, and does not provide a structured way to feed analytical results, such as learning progress or emotional state indices, back into subsequent AI inferences. This fragmented approach results in duplicated computations, inconsistent personalization behavior, and inefficient use of storage and processing resources.

In particular, emotion-related data, when used at all, is typically handled as an auxiliary signal that does not drive the core logic of content selection or difficulty adaptation. The absence of a mechanism for producing and updating an emotional state index and injecting that index into the model input means that the computer system is not technically optimized to respond to real-time changes in learner engagement or frustration. Consequently, the system cannot automatically modify prompt structures or control parameters for the generative AI model in response to changes in the learner's emotional state, and therefore cannot realize a technically improved, closed-loop control of the AI-based recommendation process.

There is therefore a need for a computer-implemented system that technically improves the functioning of a server and associated terminals by: (i) aggregating and preprocessing learning activity information into feature data; (ii) dynamically constructing model input information that combines feature data, prompt sentences, and emotion-related indices; (iii) controlling, on the server side, the contents and structure of prompts to a generative AI model; and (iv) feeding back analysis results of learning progress and emotional state into subsequent AI inferences. Such a system would not merely automate a pedagogical process, but would improve the way the computer generates, structures, and uses data for generative AI inference, thereby enhancing the computational efficiency, adaptability, and accuracy of personalized learning support.

The specific processing by the specific processing unit 290 of the data processing device 12 in Example 2 is realized by the following means.

The present invention provides a server comprising a processor configured to acquire information regarding learning activities of a learner from a terminal and store the information in a storage device, aggregate and preprocess the stored learning activity information to generate feature data representing a learning history for each learner, acquire a prompt sentence indicating a learning objective of the learner from the terminal and construct model input information by integrating the feature data and the prompt sentence, provide an instruction to a generative AI model by using the model input information so as to cause the generative AI model to generate learning proposal information including learning materials and learning tasks individually optimized for each learner, identify the learning materials and the learning tasks included in the learning proposal information by using identification information and acquire corresponding learning resources from a learning resource storage device to generate structured data in which the learning resources are associated with the learning proposal information, transmit the structured data as the learning proposal information to the terminal so that the terminal presents the learning proposal information to the learner, acquire from the terminal feedback information including learning activity results and evaluations of understanding and difficulty and store the feedback information in association with the learning activity information to update the feature data, dynamically change contents of instructions to the generative AI model based on the updated feature data and a new prompt sentence to continuously personalize learning proposal information according to a state of the learner, analyze a learning progress of the learner based on the learning activity information and the feedback information and cause the generative AI model to generate, by using an analysis result as additional context, feedback messages and modification proposals of a learning plan, acquire emotion-related data representing an emotional state of the learner and analyze the emotion-related data to generate an emotional state index, provide an instruction to the generative AI model by using model input information including the emotional state index so as to optimize contents and difficulty levels of the learning plan and the learning materials, and transmit emotion-response feedback and motivation messages generated by the generative AI model based on the emotional state index and the learning progress analysis result to the terminal so that the terminal presents the emotion-response feedback and the motivation messages to the learner. This enables the computer system to improve its internal data processing and control of generative AI inference by maintaining and updating unified feature data for each learner, dynamically generating context-rich prompt sentences and model input structures, integrating learning performance analysis and emotional state indices into subsequent model calls, and thereby providing more accurate, efficient, and adaptive personalized learning support as a technical improvement in computer functionality.

The term “system” refers to a combination of hardware and software components, including at least one server and one or more terminals, that cooperate via a communication network to perform the processing described in the claims.

The term “server” refers to an information processing apparatus that includes at least one processor, at least one storage device, and at least one communication interface, and that executes programs to perform acquisition, storage, analysis, and control of data related to learners and generative AI models.

The term “processor” refers to one or more hardware processing units, such as a central processing unit or a graphics processing unit, configured to execute instructions of one or more programs to perform the functions described in the claims.

The term “terminal” refers to an electronic device operated by a learner, such as a personal computer, a tablet device, or a mobile communication device, that is configured to transmit data to and receive data from the server and to present information to the learner. The term “storage device” refers to any non-transitory computer-readable medium, such as a magnetic storage medium, an optical storage medium, a semiconductor memory, or a combination thereof, configured to store data and programs used by the processor.

The term “communication device” refers to a hardware and software interface, such as a network interface controller and associated communication stack, configured to enable data transmission and reception between the server and one or more terminals over a communication network.

The term “learner” refers to a user who interacts with the system for the purpose of acquiring knowledge or skills by consuming learning materials and solving learning tasks.

The term “learning activity information” refers to data representing actions performed by a learner within the system, including at least one of identifiers of accessed learning materials, identifiers of attempted learning tasks, timestamps of access, response contents, correctness of responses, and time durations of activities.

The term “learning history” refers to accumulated learning activity information associated with a particular learner over time, including past interactions with learning materials and learning tasks, and derived metrics such as performance measures.

The term “feature data” refers to structured data obtained by aggregating and preprocessing learning activity information and learning history for a learner, including numerical or categorical values representing performance indicators, activity frequencies, time-related metrics, topic-related metrics, and other attributes suitable for input to a machine learning model.

The term “prompt sentence” refers to a natural-language text input that indicates at least one learning objective, preference, or request of the learner, and that is used as part of input to a generative AI model.

The term “model input information” refers to data provided to a generative AI model for inference, including at least one of feature data, a prompt sentence, analysis results, and an emotional state index, combined in a format suitable for the generative AI model. The term “generative AI model” refers to a machine learning model, such as a neural network-based model, configured to generate output data including natural-language text or structured recommendations based on input data, and to perform tasks such as content recommendation, plan generation, or feedback generation.

The term “learning proposal information” refers to information generated by the generative AI model that includes at least one of recommended learning materials, recommended learning tasks, suggested learning sequences, and explanatory texts, and that is tailored to an individual learner.

The term “learning material” refers to any instructional content provided to a learner, including at least one of textual content, audiovisual content, interactive modules, and reference documents.

The term “learning task” refers to an activity presented to a learner for practice or assessment, including at least one of questions, problems, exercises, quizzes, and assignments. The term “learning resource” refers to a stored data object representing a learning material or a learning task, including associated metadata such as identifiers, topic labels, difficulty levels, and content locations.

The term “learning resource storage device” refers to a storage device or storage subsystem configured to store learning resources and associated metadata in a retrievable manner. The term “structured data” refers to data formatted according to a predefined schema, such as a record or message including fields for identifiers, types, attributes, and links, enabling the association of learning resources with learning proposal information.

The term “feedback information” refers to data received from a terminal that represents results of a learner's interaction with learning materials and learning tasks, including at least one of correctness of answers, self-reported understanding levels, difficulty ratings, free-text comments, and timestamps.

The term “learning progress” refers to an estimated state of advancement of a learner with respect to one or more learning objectives or topics, derived from learning activity information, feature data, and feedback information.

The term “feedback message” refers to information generated for presentation to a learner that reflects an analysis of learning progress, and that may include explanations, guidance, or suggestions for improvement.

The term “learning plan” refers to an organized specification of learning objectives, recommended learning materials, recommended learning tasks, and an order or schedule for performing them.

The term “modification proposal of a learning plan” refers to information generated based on updated learning progress or emotional state, indicating changes to be made to an existing learning plan, including changes to contents, order, or difficulty levels.

The term “emotion-related data” refers to data indicative of an emotional state of a learner, including at least one of sensor signals, interaction patterns, explicit self-reports, or inferred indicators such as facial expressions or voice characteristics, as acquired by the system. The term “emotional state index” refers to one or more numerical or categorical indicators computed from emotion-related data that represent an estimated emotional state of a learner, such as engagement level, frustration level, motivation level, or fatigue level.

The term “emotion-response feedback” refers to information generated for presentation to a learner that is adapted to the learner's emotional state index and is intended to address or respond to that emotional state, such as supportive comments, encouragement, or stress-reducing guidance.

The term “motivation message” refers to a type of feedback message that is specifically designed to increase or maintain a learner's motivation, and that may include encouragement, positive reinforcement, or goal-reminder content.

The term “state of the learner” refers to a composite representation of the learner's condition at a given time, including at least learning progress, performance metrics, preferences, and emotional state index.

The term “optimize” refers to automatically adjust at least one of selection, ordering, content, or difficulty level of learning materials and learning tasks, based on model input information, in order to better match the state of the learner as estimated by the system.

In one embodiment, a server cooperates with one or more terminals used by a user who acts as a learner. The server includes at least one processor, at least one memory acting as a storage device, and at least one communication interface connected to a communication network. The terminal includes at least one processor, a display unit, an input unit such as a keyboard or touch panel, a local memory, and a communication interface. The server and the terminal execute programs stored in their respective memories to implement the functions described below.

The server executes an operating system, such as a general-purpose server operating system, and application software implemented, for example, in a programming language such as Python or a similar high-level language. The server uses software libraries for data processing, such as a table-processing library and a numerical computation library, and uses a machine learning framework such as a neural-network framework, for example a framework capable of building and executing Transformer-based neural networks. The terminal executes a web browser or a native application implemented, for example, in a language suitable for a mobile device or a personal computer.

The server stores learning activity information of each user in a database system such as a relational database management system. The server uses database tables for user accounts, learning activities, feature data, learning resources, recommendation histories, and emotion-related data. The server manages indexes on user identifiers and resource identifiers to accelerate query performance. The server stores learning resources such as text-based learning materials, audiovisual learning materials, and learning tasks in a structured content repository that may be implemented using a combination of a file storage system and a metadata database.

The terminal presents user interfaces that allow the user to log in, specify learning objectives, view recommended learning materials and learning tasks, and submit answers and feedback. The terminal transmits input data from the user to the server using a network protocol such as HTTPS, and receives response data from the server. The terminal renders received learning proposal information and feedback messages on the display unit, and the user interacts with the information through the input unit.

The server generates and updates feature data that represent learning histories of users. The server converts raw learning activity information, such as which learning materials were accessed, which learning tasks were attempted, correctness of answers, timestamps, and time durations, into normalized numerical and categorical features. For example, the server computes, for each topic and for each difficulty level, a recent correct-answer rate, an average time per task, a number of attempts, a distribution of difficulty ratings from the user, and a recency-weighted engagement score. The server stores such feature data in a dedicated feature table, where each row corresponds to a pair of a user identifier and a topic identifier, and each column corresponds to a specific feature dimension.

The server uses the feature data to construct model input information for a generative AI model. The generative AI model is, for example, a multi-layer neural network based on a Transformer architecture that includes an input embedding layer, multiple self-attention layers, feedforward layers, and an output layer for generating natural-language text tokens. The server uses a tokenizer to convert a prompt sentence and other text context into token identifiers, and embeds the tokens into continuous vectors using an embedding matrix. The server may also project numerical feature data into an embedding space and concatenate or add the projected feature embeddings to the token embeddings, or inject feature data as special tokens in the input sequence.

The server trains the generative AI model in advance using training data that include pairs of input text (containing user profiles, learning histories, and prompt sentences) and output text (containing recommended learning plans, materials, and feedback phrases). During training, the server uses a loss function such as a cross-entropy loss between predicted tokens and ground-truth tokens. The server updates neural network weights using an optimization algorithm such as stochastic gradient descent with momentum or an adaptive optimization method. The server may perform regularization such as dropout and weight decay to improve generalization. The server may use data augmentation techniques, such as paraphrasing of prompt sentences and random masking of non-critical tokens, to improve robustness. The server, during operation, executes the generative AI model in an inference mode. The server receives, from the terminal, a prompt sentence entered by the user. The prompt sentence may be, for example:
“I want to understand the basics of differential and integral calculus.”
“Please recommend beginner-friendly materials and exercises for derivatives.”
“Show me practice problems about integration that gradually increase in difficulty.”

The terminal transmits the prompt sentence as text data to the server. The server retrieves, from the feature table, the latest feature data for the corresponding user. The server constructs a text-based context that describes the user's learning history, performance metrics, and current topic focus. The server combines this context with the prompt sentence and any relevant system instructions into the input sequence for the generative AI model. In one example, the server appends a structured summary such as “Correct rate on basic derivatives: 40%. Average time per problem: 90 seconds. Recently studied topic: limits.” to the beginning of the prompt sequence.

The server executes the generative AI model to generate learning proposal information. The generative AI model produces, token by token, a sequence of output tokens representing a recommendation text. The recommendation text may contain human-readable explanations and structured markers indicating recommended learning materials and learning tasks. The server parses the output to identify markers such as resource identifiers, difficulty levels, and sequence ordering. The server then queries the learning resource storage device to retrieve actual learning resources corresponding to the identifiers mentioned in the output.

The server constructs structured data representing the learning proposal information. The structured data includes fields such as a list of learning material identifiers, titles, types, topic labels, difficulty levels, and estimated completion times, as well as a list of learning task identifiers and their metadata. The server associates the structured data with the textual explanation generated by the generative AI model. The server transmits the structured data to the terminal via the communication interface. The terminal receives the structured data and displays the proposal to the user in a user interface that reflects the suggested sequence, for example showing “Step 1: Read introduction to limits,” “Step 2: Solve basic derivative problems 1-5,” “Step 3: Watch video on definite integrals.”

The user studies the recommended learning materials and attempts the learning tasks using the terminal. The terminal records, for each interaction, data such as start time, end time, result of the answer, and any self-reported evaluation of understanding or difficulty. The user may, for example, rate a completed task as “too easy,” “appropriate,” or “too difficult,” and may input free-text comments such as “I still do not understand the chain rule” or “These integration problems are too easy.” The terminal transmits the recorded learning activity information and feedback information to the server.

The server stores the received information in association with existing learning activity information and feature data. The server updates the feature data by recalculating statistics and derived metrics. For instance, the server may increase the weight of recent activities and recalculate recency-weighted error rates by applying exponential decay functions. The server may update user-specific vectors representing topic proficiency and preference by performing incremental updates based on new observations, without retraining the entire generative AI model. This incremental update of feature data allows the server to adapt the recommendations quickly, providing a technical improvement in responsiveness and reducing the need to retrain large models frequently.

The server also acquires emotion-related data that represent an emotional state of the user. The terminal may obtain such data through explicit self-reporting interfaces, such as sliders for “motivation level” or “stress level,” or may send interaction-derived indicators such as frequency of task abandonment, rapid consecutive incorrect answers, or long idle times. Optionally, additional sensors available on the terminal, such as a camera or a microphone, may provide signals that can be processed by local or server-side modules to estimate an emotional tendency, but the core embodiment focuses on data that the terminal can encode as emotion-related scores or categories.

The server processes the emotion-related data to compute an emotional state index. For example, the server may combine self-reported motivation scores with interaction-based indicators by using a weighted average or a small auxiliary neural network that outputs a scalar or vector index. The server normalizes the emotional state index to a predetermined range and stores it with timestamps in an emotion index table. The server uses this index as an additional component of the model input information. For instance, the server may insert a phrase such as “Current engagement: low; frustration: high; motivation: moderate” into the context portion of the prompt, or may encode the index as special tokens appended to the prompt sequence. By injecting the emotional state index into the input, the server allows the generative AI model to adjust the style and difficulty of generated recommendations. The server, in another embodiment, uses a multi-head attention mechanism inside the generative AI model to attend not only to token sequences from the prompt sentence and context, but also to feature vectors representing learning history and the emotional state index. In this embodiment, the server constructs a multi-modal input where one branch carries token embeddings from text, and another branch carries numerical feature embeddings. Attention layers can then learn to focus on different aspects of the learner state when generating each token. This architecture enhances the capability of the computer system to compute recommendations that are sensitive to performance trends and emotional conditions, and it cannot be achieved by manual rule-based systems or static prompts. The server controls the content and structure of prompt sentences provided to the generative AI model. For example, when the server detects that the emotional state index indicates high frustration and low motivation, the server modifies the system instruction portion of the prompt to emphasize supportive and motivational messaging, and restricts the difficulty level of recommended tasks. When the server detects stable high performance on a given topic, the server modifies the prompt to request more challenging tasks and to emphasize progression to advanced topics. The server applies decision rules implemented as algorithms that map feature data and emotional state indices to prompt templates and control parameters of the generative AI model, such as a temperature parameter, a maximum output length, or a penalty for repetitive tokens. This dynamic prompt control reduces the need for manual tuning by human operators and allows the computer system to autonomously optimize AI outputs.

The server improves computer-technical performance by structuring data and computation in a way that reduces redundant processing and network traffic. Because the server maintains explicit feature tables and emotional state indices, the server does not need to re-scan large volumes of raw log data for each recommendation; instead, the server queries compact feature vectors and updates them incrementally. This design results in lower database query latency and reduced CPU usage. The server further improves communication efficiency by transmitting structured identifiers of learning resources rather than complete content data in every interaction, allowing caching strategies on the terminal side.

The server, through the described architecture, improves the precision and speed of generating personalized learning proposals as compared to conventional systems that rely solely on static rules or simple collaborative filtering. By using a generative AI model that consumes feature data and emotional state indices in addition to a prompt sentence, the server can generate recommendations with higher accuracy and contextual relevance. This leads to fewer iterations needed for the user to receive suitable content, which in turn saves computational and communication resources.

The server implements multiple alternative embodiments for the generative AI model and associated processing. In one embodiment, the server uses a single large Transformer model that directly generates natural-language recommendations and resource identifiers. In another embodiment, the server uses a pipeline in which a first model generates a high-level learning plan text and a second, smaller model or a rule-based engine maps items in the plan to specific learning resources by matching topic labels and difficulty levels. In yet another embodiment, the server uses a neural retrieval component that maps both user state vectors and resource metadata into a shared embedding space, and selects nearest neighbor resources prior to calling a generative language model for explanation generation.

The server may further support different training strategies. In a supervised fine-tuning embodiment, the server uses labeled training data that pair user histories with expert-crafted plans and feedback. In a reinforcement-learning embodiment, the server uses subsequent user performance metrics and satisfaction scores as rewards, and updates model policies to favor actions that lead to improved learning outcomes. The server may log the effect of each recommendation, such as change in error rates or improvement in self-reported understanding, and use this information in periodic batch training to refine model parameters. The terminal, in all embodiments, remains relatively lightweight in computation. The terminal focuses on user interaction, local caching of frequently used learning resources, and responsive rendering of interfaces. The technical contribution mainly resides in the server-side data structures, feature computation, dynamic prompt generation, and multi-modal input construction for the generative AI model. The combination of these elements results in a computer system that not only automates the presentation of learning materials but also enhances the underlying processing of data and control of AI models, thereby producing a technical improvement in the functioning of the computer itself.

The user in these embodiments is not required to manage internal technical details. The user simply interacts with the terminal by entering prompt sentences, such as “I want to understand the basics of differential and integral calculus,” selecting difficulty ratings, and optionally reporting emotional states. The server translates such simple actions into complex data processing steps and model control strategies that the user need not be aware of. Because of this, the system provides a technically sophisticated backend while maintaining a simple and accessible frontend user experience.

Through these configurations, the server, the terminal, and the user cooperate in a manner that goes beyond a mere automation of human tutoring. The server introduces specific data structures, processing algorithms, and generative AI model architectures that improve processing speed, recommendation precision, and adaptability, and thereby realize a technical effect in terms of improved computer functionality and efficient resource use.

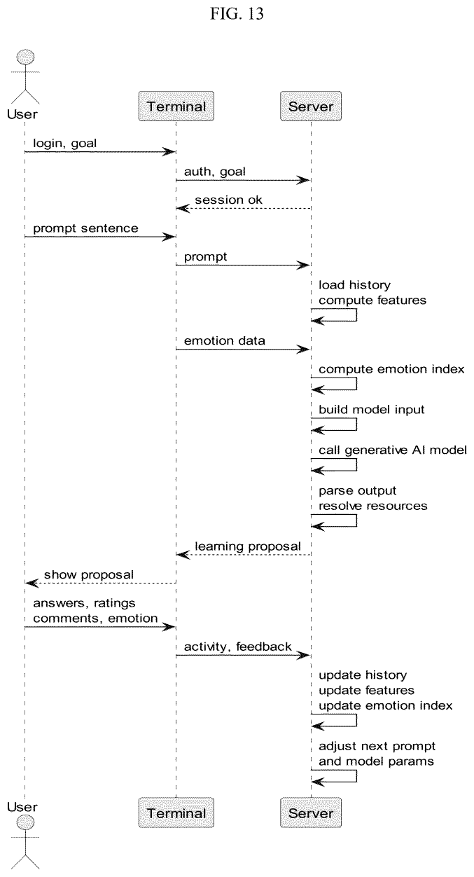

The following describes the processing flow using FIG. 13.

### Step 1

The terminal displays a login screen and learning dashboard to the user.

The user inputs authentication information and optionally selects or inputs a current learning objective.

Input: User credentials and optional initial learning objective.

The terminal packages these inputs into a request message, attaches device and timestamp metadata, and transmits the message to the server via a secure network connection.

Output: An authenticated session request sent from the terminal to the server.

### Step 2

The server receives the authentication and objective data from the terminal.

Input: Request message containing user credentials and optional learning objective.

The server verifies the credentials against a user account table in a relational database, creates or updates a session record, and associates any initial learning objective with the user profile. The server reads existing feature data and learning history records for the user and loads them into memory.

Output: An authenticated user session on the server and in-memory structures representing the user profile and previously stored feature data.

### Step 3

The terminal presents an input field for a prompt sentence to the user.

The user enters a prompt sentence describing a desired learning goal or request, for example:
“I want to understand the basics of differential and integral calculus.”
“Please recommend beginner-friendly materials and exercises for derivatives.”
“Show me practice problems about integration that gradually increase in difficulty.”

Input: Prompt sentence typed by the user.

The terminal encapsulates the prompt sentence together with the user identifier and session identifier into a structured request and sends it to the server.

Output: A prompt-sentence request transmitted to the server.

### Step 4

The server receives the prompt sentence and prepares raw learning activity information. Input: Prompt sentence, user identifier, and session identifier.

The server queries a learning-activity table to retrieve records for the user, including identifiers of past learning materials and tasks, timestamps, correctness flags, and time durations. The server loads these records into an in-memory data structure, such as a table or array. The server then validates and cleans the data, removing invalid entries and normalizing timestamps to a standard format.

Output: A cleaned set of learning-activity records in memory for the user.

### Step 5

The server generates and updates feature data representing the learning history.

Input: Cleaned learning-activity records.

The server aggregates the records by topic, difficulty level, and time window. The server computes statistics such as recent correct-answer rates, numbers of attempts per topic, average time per task, standard deviations of response times, rolling error rates, and recency-weighted engagement scores. The server encodes categorical fields (e.g., topic labels, task types) as numerical identifiers and normalizes numerical values using scaling functions. The server writes these aggregated statistics into a feature table and forms a feature vector for each relevant topic.

Output: Updated feature data stored in a feature table and feature vectors in memory for use as model input.

### Step 6

The terminal collects emotion-related inputs from the user.

Input: User manipulation of UI components such as sliders or buttons indicating “motivation level,” “stress level,” or “fatigue level,” and interaction patterns such as rapid task abandonment or long idle times.

The terminal converts these inputs into numeric or categorical codes, attaches timestamps and resource identifiers, and transmits them to the server in a dedicated emotion-data request. Output: An emotion-related data message sent from the terminal to the server.

### Step 7

The server processes the emotion-related data to compute an emotional state index.

Input: Emotion-related data message containing self-reported scores and interaction-derived indicators.

The server merges the received data with any existing emotion records for the user, applies weighting factors to different indicators, and calculates one or more summary values representing engagement, frustration, and motivation. The server may apply a small auxiliary model or a rule-based algorithm, such as a weighted average combined with thresholds, to transform raw scores into a normalized emotional state index vector. The server stores the index in an emotion-index table with timestamps.

Output: A current emotional state index for the user, available as a numerical vector in memory and stored in the database.

### Step 8

The server constructs model input information for a generative AI model.

Input: Prompt sentence, feature vectors from the feature table, and the emotional state index. The server builds a textual context that summarizes key performance indicators and emotional state, for example: “Correct rate on basic derivatives: 40%. Average time per problem: 90 seconds. Current engagement: low. Frustration: high.” The server concatenates this context with the prompt sentence and system instructions into an input text sequence. The server then tokenizes the sequence using a tokenizer to convert words and symbols into token identifiers. The server maps the token identifiers to embedding vectors and, if used, projects numerical feature data and emotional indices into an embedding space and concatenates or merges them with token embeddings.

Output: A combined model input representation consisting of token embeddings and feature embeddings for use by the generative AI model.

### Step 9

The server configures and invokes the generative AI model.

Input: Combined model input representation and control parameters such as temperature, maximum output length, and repetition penalties.

The server loads a trained generative AI model, for example a Transformer-based neural network with multiple self-attention layers and feedforward layers, into memory on a computing device such as a CPU or GPU. The server passes the input embeddings through the model's layers, where the model performs matrix multiplications, attention-weight calculations, non-linear activations, and layer normalizations to generate output token probability distributions step by step. The server samples or selects tokens according to the control parameters until a termination criterion is met.

Output: A sequence of output tokens representing generated natural-language text that contains a learning proposal and optionally structured markers.

### Step 10

The server parses the model output and resolves learning resources.

Input: Generated token sequence representing recommendation text.

The server detokenizes the sequence into text and scans for structured expressions or markers that encode resource references, topic names, and difficulty levels. The server applies pattern-matching rules or a lightweight parser to extract candidate resource identifiers or descriptions. The server queries a learning-resource storage device using these identifiers or using search keys derived from the text, and retrieves corresponding learning materials and tasks. The server constructs structured data objects that associate the retrieved resource metadata—such as titles, types, topic labels, and difficulty levels—with segments of the generated recommendation text.

Output: Structured learning proposal data that combines explanation text with specific learning resource references.

### Step 11

The server transmits the learning proposal to the terminal.

Input: Structured learning proposal data and the generated recommendation text. The server packages the data into a response message, including lists of learning materials, lists of learning tasks, sequence ordering, and explanatory messages. The server records the proposal in a recommendation-history table for later analysis, then sends the response message over the network to the terminal.

Output: A learning proposal response delivered to the terminal.

### Step 12

The terminal receives and displays the learning proposal to the user.

Input: Learning proposal response message from the server.

The terminal parses the message, extracts the list of recommended items and associated explanations, and renders them on the display unit using graphical components such as lists, buttons, and progress indicators. The terminal arranges items according to the recommended sequence, for example “Step 1: Read material A,” “Step 2: Solve tasks 1-5,” “Step 3: Watch video B,” and shows difficulty levels and estimated times.

Output: A visible and interactive user interface through which the user can view and select recommended learning materials and tasks.

### Step 13

The user studies the recommended materials and attempts the recommended tasks.

Input: Displayed learning resources and tasks on the terminal.

The user opens materials, reads texts, watches videos, and inputs answers to tasks using the input unit. The user optionally selects difficulty ratings (e.g., “too easy,” “appropriate,” “too difficult”) and enters comments regarding understanding. The user may also adjust self-reported emotion indicators during or after studying.

Output: User-generated interaction data including answers, ratings, comments, and updated emotion indications.

### Step 14

The terminal records and transmits updated learning activity and feedback information. Input: User-generated interaction data including answers, correctness results, duration per activity, difficulty ratings, understanding ratings, comments, and updated emotion indicators. The terminal logs each interaction with timestamps and resource identifiers, composes log entries for learning activity information and feedback information, and batches the entries into request messages. The terminal transmits the batched messages to the server via the communication interface, optionally using buffering when the network connection is unstable.

Output: Learning-activity messages and feedback messages delivered to the server.

### Step 15

The server integrates the new activity and feedback data and updates internal state.

Input: Learning-activity messages and feedback messages for the user.

The server inserts the new records into the learning-activity table and feedback table, associates them with existing records using user identifiers and resource identifiers, and recomputes feature data for affected topics and time windows. The server recalculates metrics such as recent error rates, updated average times, and new difficulty distributions, and stores the revised feature vectors. The server also merges new emotion-related data into the emotion index computation and updates the emotional state index accordingly.

Output: Updated feature data and emotional state index stored in the database and available in memory for subsequent recommendations.

### Step 16

The server adjusts future model input and prompt control based on updated state. Input: Updated feature data, updated emotional state index, and any new prompt sentence received in later interactions.

The server applies decision rules or auxiliary models that map changes in performance and emotional state to modified prompt templates and model control parameters. The server may lower difficulty thresholds, increase supportive language in instructions, or narrow topic focus when frustration is high, or it may expand topic coverage and increase difficulty when performance is consistently strong. The server encodes these adjustments in the context text and in numerical control settings that influence the next call to the generative AI model.

Output: A revised configuration for model input construction and generative AI model invocation that will be used in subsequent recommendation cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support systems typically treat personalization as a static content selection problem driven by simple rules or coarse user profiles. In such systems, a processor often retrieves precomputed recommendations from storage based on a small set of parameters, such as grade level or previously viewed items, and then presents fixed content flows to a learner terminal. These architectures have several technical limitations from the standpoint of computer technology.

First, existing systems generally lack an integrated mechanism by which a processor dynamically generates and updates machine-interpretable control instructions, such as internal prompt sentences, for a generative AI model based on fine-grained, continuously updated learning state information. As a result, the use of generative AI models, when present at all, tends to be ad hoc and offline: the models may be invoked to create static learning plans or generic feedback messages, but the instruction interface between the application logic and the generative AI model is not structurally tied to live behavioral and emotional signals. This leads to inefficient use of computational resources on both the application side and the model side, because the same generic prompts are reused regardless of changing learner context, and the output must be heavily post-processed or discarded.

Second, many existing systems do not combine, at the processor level, multi-modal learning behavior logs and emotion state data into a unified learning state representation that is subsequently fed back into the control loop. Learning behavior information such as correctness rates, response times, and navigation logs is typically processed in isolation from emotion-related information acquired from image or audio data. Without a unified representation that includes emotion load information per learning unit, the processor cannot dynamically adjust model inputs, content difficulty, or presentation order in a manner that is responsive to both cognitive and affective states. This results in suboptimal flows, increased server-client traffic due to unnecessary or poorly targeted content transmissions, and a failure to exploit available sensor data for intelligent control.

Third, in many implementations the processor interacts with generative models only at the level of raw natural language, without structuring prompts or outputs to match the internal content indices and control structures of the learning system. Such loosely coupled interactions require extensive manual curation or runtime heuristics to map generated text back into database entities. This mapping is computationally inefficient, error-prone, and not robust to model variation, and it prevents effective automation of learning plan updates, difficulty adjustments, and feedback generation.

Fourth, traditional architectures rarely implement an iterative, closed-loop pipeline in which the processor repeatedly: (i) aggregates learning logs and emotion states into numerical learning state information, (ii) uses the learning state information to generate internal prompt sentences, (iii) invokes a generative information processing model with such internal prompt sentences, (iv) parses the output into structured learning plan data and feedback data, and (v) pushes updated prompts to the learner terminal for immediate selection and execution. Without such a closed-loop, the system cannot continuously adapt both the server-side planning logic and the terminal-side user interface to the learner's evolving condition using a single, unified computational workflow.

Accordingly, there is a need for an improved computer-implemented learning system in which a processor constructs and maintains a rich, numerically expressed learning state that includes emotion load information, uses that state to automatically synthesize internal prompt sentences for a generative AI model, and employs the resulting model outputs to dynamically update learning plans, content selections, and user-facing prompt sentences. Such a system should provide a technical improvement by reducing redundant processing, stabilizing the integration between generative models and structured content indices, and enabling more efficient, responsive control of content transmission and user interface behavior over a networked environment.

The specific processing by the specific processing unit 290 of the data processing device 12 in Application Example 2 is realized by the following means.

The present invention provides a server comprising a processor configured to acquire learner attribute information, learning goal information, and learning history information from a learner terminal, arrange the learning history information in chronological order, calculate, for each learning unit, correctness rate information, response time information, and learning frequency information, store the calculated information as learning state information, convert the learning state information into numerical data and calculate, by using a machine learning model, understanding degree information for each learning unit and priority learning unit information, generate an internal prompt sentence to be input to a generative information processing model on the basis of the understanding degree information, the priority learning unit information, and the learning goal information, and transmit inquiry data including the internal prompt sentence to the generative information processing model, analyze output data obtained from the generative information processing model, extract learning plan information for learning sessions, learning material candidate information, and learning feedback candidate information, select, from a learning content storage unit, concrete learning content corresponding to the learning material candidate information to construct individualized optimized learning content information, generate, on the basis of the individualized optimized learning content information and the learning feedback candidate information, a user interface prompt sentence for presentation on the learner terminal, and transmit the user interface prompt sentence to the learner terminal, acquire, from the learner terminal, learning behavior log information including browsing operation information for learning content, problem answer result information, screen transition information, and time information corresponding to the browsing operation information and the problem answer result information, and update the learning state information, acquire, from the learner terminal or from an external emotion analysis service, image information, audio information, or emotion index information calculated from the image information or the audio information, estimate emotion state information during learning by associating the acquired information with the learning behavior log information, calculate emotion load information for each learning unit by associating the emotion state information with the understanding degree information, generate difficulty adjustment information, presentation order change information, and additional auxiliary material selection information on the basis of updated learning state information including the emotion load information, generate, on the basis of the updated learning state information and the difficulty adjustment information, a new internal prompt sentence that takes into account the emotion state and learning progress, instruct the generative information processing model, by using the new internal prompt sentence, to perform modification of a learning plan and generation of an encouraging message, dynamically update the learning plan information and learning feedback information on the basis of an output result from the generative information processing model, and transmit, to the learner terminal, the updated learning plan information, the learning feedback information, and a prompt sentence for allowing a learner to select among the updated learning plan information and the learning feedback information, and repeatedly perform presentation of learning content and presentation of feedback during a learning session. This enables the server to implement an integrated, closed-loop control architecture in which multi-modal learning behavior data and emotion state data are transformed into structured learning state information, internal prompt sentences are automatically synthesized and supplied to a generative information processing model, and the model's outputs are deterministically mapped back into indexed content selections and user interface prompt sentences, thereby improving the efficiency, robustness, and responsiveness of computer-based learning plan generation, content recommendation, and feedback delivery.

The term “learner” refers to a human user who interacts with the system via a terminal to receive learning content, perform learning activities, and provide implicit or explicit feedback.

The term “learner terminal” refers to an information processing device, such as a portable terminal, a stationary terminal, or a head-mounted display, that presents learning content and prompt sentences to a learner and transmits learning-related data to the server.

The term “server” refers to an information processing apparatus, typically including one or more processors and storage units, configured to execute the functions of acquiring, analyzing, and updating learning state information and controlling interactions with a learner terminal.

The term “processor” refers to a hardware computation unit, such as a central processing unit or a graphics processing unit, configured to execute computer-executable instructions to perform the processes described in the present disclosure.

The term “learning unit” refers to a smallest logical topic or segment of learning, such as a concept, a subtopic, a lesson, or a problem category, for which the system evaluates understanding degree and emotion load.

The term “attribute information” refers to data describing static or slowly changing characteristics of a learner, such as age range, proficiency level, or target domain, which are used to contextualize learning goals and state.

The term “learning goal information” refers to data indicating one or more desired learning outcomes for a learner, including target scores, deadlines, or target competencies, as used by the processor to plan learning activities.

The term “learning history information” refers to chronological records of past learning activities of a learner, including problems attempted, materials accessed, correctness results, timestamps, and interaction traces.

The term “learning state information” refers to structured data representing a current overall state of a learner, derived from learning history information and including metrics such as correctness rates, response times, learning frequencies, understanding degrees, and optionally emotion load.

The term “correctness rate information” refers to numerical information indicating a proportion of correct responses versus attempted responses for each learning unit within a specified period.

The term “response time information” refers to temporal information indicating durations taken by a learner to respond to learning tasks, such as problem solving or content viewing, for each learning unit.

The term “learning frequency information” refers to information indicating how often or how many times a learner has engaged with tasks or materials associated with a particular learning unit.

The term “numerical data” refers to data that have been transformed into numeric representations, suitable for processing by statistical or machine learning algorithms. The term “machine learning model” refers to a computational model, such as a neural network or other statistical learning algorithm, that has been trained using data and is used by the processor to infer properties such as understanding degree or priority learning units. The term “understanding degree information” refers to information indicating a degree or level of a learner's comprehension or mastery for each learning unit, as inferred by the machine learning model.

The term “priority learning unit information” refers to information indicating which learning units should be preferentially targeted in subsequent learning activities based on the current learning state.

The term “generative information processing model” refers to a machine-implemented model capable of generating new information, such as text, structured plans, or recommendations, in response to input data including a prompt sentence.

The term “internal prompt sentence” refers to a control instruction expressed in natural language or a structured format, generated by the processor and not necessarily exposed to the learner, that is supplied as input to the generative information processing model to specify a desired output behavior.

The term “inquiry data” refers to data transmitted from the server to the generative information processing model, including at least one internal prompt sentence and optionally associated parameter data.

The term “output data” refers to information generated by the generative information processing model in response to inquiry data, including proposed learning plans, content suggestions, and feedback messages.

The term “learning plan information” refers to structured data describing a sequence or set of learning activities, sessions, or topics to be performed by a learner over time.

The term “learning material candidate information” refers to data indicating one or more candidate types or topics of learning materials that are proposed by the generative information processing model for potential selection.

The term “learning feedback candidate information” refers to data indicating candidate feedback messages or feedback structures proposed for presentation to a learner.

The term “learning content storage unit” refers to a storage resource, such as a database or memory, in which learning contents including problems, explanations, and media materials are stored with associated indices.

The term “concrete learning content” refers to specific learning resources, such as individual questions, examples, explanations, or media items, that can be directly delivered to and rendered on a learner terminal.

The term “individualized optimized learning content information” refers to structured information specifying a set of concrete learning contents selected and configured for a particular learner based on the learner's learning state information.

The term “user interface prompt sentence” refers to a sentence or message generated by the processor for display on a learner terminal, prompting a learner to make a choice, confirm an action, or understand a recommended next step.

The term “learning behavior log information” refers to data representing detailed behavior of a learner when interacting with learning content, including operation events, answer results, navigation events, and associated timestamps.

The term “browsing operation information” refers to information describing how a learner has operated a user interface when viewing learning content, such as clicks, scrolls, and open or close events.

The term “problem answer result information” refers to information indicating how a learner responded to a problem, including correctness, selected answers, and partial scoring where available.

The term “screen transition information” refers to information indicating movement between different display states or pages on a learner terminal during a learning session.

The term “time information” refers to temporal data associated with learner actions or events, such as timestamps and durations, used for constructing chronological sequences and computing time-based metrics.

The term “image information” refers to visual data obtained from a capture device, such as frames or sequences acquired by a camera associated with a learner terminal.

The term “audio information” refers to sound data obtained from an audio capture device, such as spoken voice or ambient audio, associated with a learner terminal.

The term “emotion index information” refers to derived numerical indicators representing emotion-related states, calculated from image information, audio information, or a combination thereof by an emotion analysis process.

The term “emotion state information” refers to information representing an estimated emotional condition of a learner during learning, such as stress, frustration, engagement, or confidence, associated with specific times or learning units.

The term “emotion load information” refers to information representing a degree of emotional burden or difficulty experienced by a learner in connection with a particular learning unit.

The term “difficulty adjustment information” refers to information used by the processor to adjust a difficulty level of learning content or tasks to be presented to a learner. The term “presentation order change information” refers to information indicating modifications to an order in which learning units or learning contents are presented to a learner.

The term “additional auxiliary material selection information” refers to information indicating selection of supplementary materials, such as hints, review items, or introductory explanations, to be added to a planned learning sequence.

The term “updated learning state information” refers to learning state information that has been modified to incorporate new learning behavior log information and emotion-related information.

The term “learning progress” refers to a change over time in a learner's learning state, including improvements or regressions in understanding degree for one or more learning units.

The term “encouraging message” refers to a feedback message generated for a learner that is intended to provide reassurance, motivation, or emotional support in relation to learning activities.

The term “learning feedback information” refers to structured feedback data that may include explanations, performance evaluations, and encouraging messages generated for a learner. The term “prompt sentence for allowing a learner to select” refers to a user interface message that presents alternatives, such as different learning paths or content items, and solicits a selection input from the learner.

The term “learning session” refers to a continuous or logically grouped period of interaction during which a learner engages in one or more learning activities under control of the system. The term “learning period information” refers to information indicating a total time frame, such as days or weeks, available for achieving one or more learning goals.

The term “target achievement value information” refers to numerical targets, such as desired scores, completion rates, or mastery levels, that define success criteria for learning goals. The term “learning session allocation information” refers to information specifying how learning sessions are to be distributed over a time period, such as number of sessions per day or per week.

The term “learning amount allocation information” refers to information specifying quantities of learning tasks or content, such as number of problems or units, to be undertaken in each learning session.

The term “long-term learning plan information” refers to structured information describing learning activities scheduled over an extended period, including session allocation and content distribution designed to meet defined goals.

The term “ambiguous preference information” refers to loosely specified learner preferences, such as general interests or qualitative statements, that do not directly define concrete learning goals.

The term “free-description goal information” refers to goal descriptions entered by a learner in natural language without a predefined format.

The term “learning goal candidates” refers to possible specific learning goals generated by the system from ambiguous or free-description inputs.

The term “evaluation index candidates” refers to possible metrics or indicators for measuring achievement of learning goals, generated by the system for subsequent selection or confirmation.

The term “automatically generate the learning goal information” refers to the act of the processor creating structured learning goal information without requiring manual formulation of such structure by the learner.

In one embodiment, a server implements the claimed system by executing computer programs on general-purpose hardware including at least one central processing unit, at least one graphics processing unit, a main memory, a non-volatile storage device, and a network interface. The server runs an operating system such as a general-purpose server operating system and uses software libraries including, for example, a numerical computation library, a machine learning framework such as a deep learning framework, a database management system, and a web server framework. The server communicates with one or more learner terminals via a network such as the Internet using standard communication protocols. A learner terminal operates as a client device and can be implemented as a smartphone, a tablet computer, a notebook computer, a desktop computer, or a head-mounted display. The learner terminal includes at least one processor, a display unit, an input unit such as a touchscreen or keyboard, a camera, a microphone, and a network interface. The learner terminal executes a learning application that renders user interface prompt sentences, displays learning content, records learner interactions, and acquires sensor data such as image information and audio information.

A user operates the learner terminal to register as a learner, to specify one or more learning goals, and to interact with learning content. The user inputs learning goal information such as “achieve a score of 80 or higher on a mathematics test in 4 weeks,” or “understand basic and intermediate concepts in differential and integral calculus.” The user also allows, with consent, the learner terminal to access the camera and microphone so that emotion-related information can be acquired.

The server stores learner attribute information, learning goal information, and learning history information in a structured database. In one embodiment, the server uses a relational database system and defines tables for learners, learning units, learning activities, sensor events, and emotion states. Each learning activity record includes a learner identifier, a learning unit identifier, correctness result, response start time, response end time, intermediate interaction events, and references to content identifiers. Each sensor event record includes a learner identifier, timestamps, raw or preprocessed image feature vectors, raw or preprocessed audio feature vectors, and emotion index values returned from an emotion analysis service.

The server uses a numerical computation library and a machine learning framework to construct a learning state information data structure. The server converts learning history records into feature vectors per learning unit by computing aggregated metrics such as correctness rate, mean and variance of response time, number of attempts, and recency features such as exponentially decayed counts. The server stores these aggregated metrics in a learning state table or an in-memory cache keyed by learner identifier and learning unit identifier.

In one embodiment, the server implements a multi-layer neural network to realize the machine learning model that outputs understanding degree information and priority learning unit information. The neural network can be a feed-forward architecture with an input layer, two or more hidden layers, and an output layer. The input layer receives a feature vector for each learning unit, where the feature vector includes normalized correctness rate, log-transformed average response time, attempt frequency, and one-hot or embedding representations of the learning unit. The hidden layers perform affine transformations followed by non-linear activation functions such as rectified linear units. The output layer generates continuous scores representing understanding degree for each learning unit and optional binary or multi-class outputs indicating whether the learning unit should be considered a priority learning unit.

The server trains this neural network offline using historical data from many learners. The server divides the data set into training and validation subsets and uses an optimization algorithm such as stochastic gradient descent or an adaptive gradient method. The server defines a loss function that combines a regression term (for example, mean squared error between predicted understanding degree and ground truth scores) with a classification term (for example, cross-entropy between predicted priority flags and labels derived from subsequent performance). The server performs forward and backward propagation on batches of training examples, computes gradients of the loss with respect to network weights, and updates the weights according to the optimization algorithm. In some embodiments, the server applies regularization techniques such as dropout or L2 weight decay, and uses data augmentation on temporal features (for example, jittering timestamps within tolerance intervals) to improve generalization.

The server uses a separate generative AI model as a generative information processing model. In one embodiment, the generative AI model is a transformer-based language model implemented in the machine learning framework and deployed as a service accessible via an API. The model has multiple self-attention layers, feed-forward sublayers, and layer normalization components. The model is pre-trained on large-scale text data to learn general language patterns and is then fine-tuned using domain-specific data such as learning plans, teacher feedback examples, and content catalog descriptions. The server stores the trained model weights on a storage device and loads them into GPU memory for fast inference. The server does not simply pass human-authored prompts to the generative AI model; instead, the server automatically generates internal prompt sentences based on the numerically expressed learning state information and emotion-related information. The server constructs an internal prompt sentence by combining template fragments with dynamically computed values, such as:
“The learner's goal is to reach a target score of 80 or higher on a mathematics examination in 4 weeks. The learner has a high understanding of basic differentiation (correctness 90%, short response time), a moderate understanding of integration by substitution (correctness 65%, moderate response time), and a low understanding of differential equations (correctness 40%, long response time). The learner has recently shown signs of anxiety when solving differential equation problems. Generate a 5-session learning plan focusing on improving differential equations, including specific activity types (such as worked examples, easy practice problems, and summary quizzes), and produce one short encouraging feedback message suitable for a learner who feels anxious.”

The server encodes this internal prompt sentence as a sequence of tokens, inputs it to the generative AI model, and obtains output tokens. The model performs multi-head self-attention, computing context-dependent representations for each token by aggregating weighted information from other tokens. The feed-forward sublayers process these representations, and the final layer generates probability distributions over possible next tokens. The server samples or selects tokens according to a decoding strategy such as greedy decoding or top-k sampling to form an output text that describes a proposed learning plan and feedback messages.

The server processes the output text by applying parsing rules. In one embodiment, the server constrains the generative AI model via the internal prompt sentence to output a semi-structured format, such as enumerated sessions and clearly marked sections for “Session 1:”, “Session 2:”, and “Feedback:”. The server parses these sections by text pattern matching and maps textual topic names to internal learning unit identifiers by using a term-to-ID dictionary stored in the database. This mapping allows the server to convert free-form generative outputs into deterministic references to indexed learning content.

The server then uses a learning content storage unit, such as a content database, to select concrete learning content corresponding to each proposed session entry. For example, if the output includes a line “Provide three easy practice problems on first-order differential equations with detailed step-by-step solutions,” the server searches the content database for items tagged as “first-order differential equations,” difficulty level “easy,” and content type “practice problem with solution.” The server may implement ranking rules or an auxiliary scoring function to select content that has historically led to good outcomes, thereby improving recommendation quality and computational efficiency by reducing the candidate set before transmission.

The server generates user interface prompt sentences for the learner terminal by transforming internal specifications into natural language. For example, based on the chosen content and feedback data, the server may generate prompt sentences such as:
“Would you like to review a simple example of a first-order differential equation before attempting more problems?”
“Do you want to practice 5 easy problems similar to the one you just missed?”
“These topics look strong. Shall we move on to integral calculus, or continue strengthening differential equations?”

The learner terminal displays these prompt sentences in dialog boxes or banners and provides selectable options such as buttons labeled “Yes, show me,” “Skip for now,” or “Practice more.” The user chooses an option, and the learner terminal generates an event with an associated timestamp and sends this event to the server as part of learning behavior log information.

The learner terminal acquires image information and audio information while the user is interacting with learning content. The learner terminal uses a vision library to detect facial landmarks and to derive features such as eyebrow raise, mouth curvature, and eye openness, and uses an audio processing library to compute features such as pitch, energy, and speech rate. The learner terminal or an external emotion analysis service transforms these features into emotion index information such as scores for “joy,” “frustration,” “confusion,” and “anxiety.” The server receives these indices and associates them with learning activities based on timestamps and content identifiers.

The server estimates emotion state information and emotion load information by aggregating emotion indices over activities associated with each learning unit. For example, the server may compute an average “anxiety score” for all differential equation problems attempted in the last 7 days and normalize it against baseline values. The server creates a composite feature vector that includes both cognitive features (correctness, time, attempts) and affective features (emotion scores) for each learning unit. The server feeds this composite vector into a secondary model or a rule-based component that classifies the emotion load as “low,” “medium,” or “high.”

The server uses the combined understanding degree information and emotion load information to generate difficulty adjustment information, presentation order change information, and additional auxiliary material selection information. For example, the server applies rules such as:
If understanding degree is low and emotion load is high, then decrease difficulty level by one step and insert auxiliary materials such as basic explanations and step-by-step worked examples.
If understanding degree is moderate and emotion load is low, then maintain or slightly increase difficulty and add mixed review problems.
If understanding degree is high and emotion load is low, then prioritize advanced problems and reduce repetition to avoid unnecessary processing and transmission.

By explicitly encoding such rules, the server controls not only which content is chosen, but also in what order and with what level of scaffolding. This combination of rule-based adjustment with model-based inferences constitutes a non-conventional control flow that improves technical behavior, because it reduces the number of unnecessary content transmissions and prevents repeated generation of unsuitable recommendations, thereby lowering network traffic and server computation load.

The server updates the learning state information in the database after each batch of new learning behavior log information and emotion-related information. The server recomputes aggregated metrics and, in some embodiments, incrementally updates the machine learning model's predictions for understanding degree and priority learning units using online learning techniques. The server can apply mini-batch updates for the neural network based on newly accumulated error signals, using the same loss functions and optimization algorithms as in the offline training, but constrained to small updates to preserve stability.

In another embodiment, the server uses multiple generative AI models tailored to different sub-tasks. A first generative AI model is used primarily for learning plan generation, while a second generative AI model is specialized for feedback and motivational messages. The server decides which model to call and how to structure the internal prompt sentence based on metadata in the learning state information, such as “planning required” flags or “feedback only” flags. This modular approach enables the server to improve computational efficiency by restricting heavy generative processing to points where it significantly influences the learning sequence and by using lighter, rule-based text templates when only minor adjustments are required.

The system provides technical improvements beyond mere automation of human decision-making. By converting heterogeneous data streams (learning logs, sensor-based emotion indices) into a normalized learning state representation and using that representation to synthesize internal prompt sentences, the server reduces noise and ambiguity in the instructions given to the generative AI model. This leads to more stable and predictable outputs, which in turn simplifies the mapping back to structured content indices. Because the server constrains the generative output through semi-structured prompts and parses the output using known patterns, the server can avoid repeated trial-and-error calls to the model and expensive human moderation, thereby improving processing speed and computational efficiency.

The use of an integrated closed-loop, in which model outputs directly influence subsequent log acquisition and prompt design, further improves system performance. For example, once the server detects that a certain content category consistently yields high emotion load and low learning gains, the server reduces the frequency of such content in future plans and adjusts prompts to steer the learner to alternative resources. This reduces wasted bandwidth and compute cycles on both the server and learner terminal, while improving the precision of future model predictions because the system avoids collecting redundant or uninformative data.

In one variation, the server deploys the machine learning model and generative AI model across multiple processing units. The server assigns numerical aggregation and model pre-processing tasks to the central processing unit, while offloading neural network inference to the graphics processing units. This parallelization allows the server to process many learners' data concurrently, enabling real-time adaptation within large-scale deployments. By batching internal prompt sentences for multiple learners and performing vectorized inference on the generative AI model, the server reduces per-request overhead and increases throughput. In another variation, the learner terminal performs some of the preprocessing and emotion estimation locally, using on-device models and caching. The learner terminal may maintain a short-term cache of feature vectors and compressed logs and only transmit aggregated data periodically or when a significant event occurs. This architecture reduces continuous network traffic and latency and enables partial operation in environments with limited connectivity. The server then integrates these periodic updates into its centralized learning state representation.

In yet another embodiment, the server adjusts the granularity of learning units based on observed performance and emotion patterns. When the server detects that a large learning unit such as “differential equations” consistently shows heterogeneous performance and emotion load, the server may split the unit into finer-grained sub-units, for example “first-order linear differential equations,” “separable equations,” and “applications to growth and decay.” The server updates its internal mapping tables and modifies future internal prompt sentences to reference these sub-units. This dynamic adjustment of the data structure underlying learning units provides a technical effect: it allows the models to operate on more homogeneous feature vectors and to produce more accurate understanding degree and emotion load estimates, which improves the precision of difficulty adjustments and content selection.

As a concrete example of use, the user may specify via the learner terminal: “I want to understand differential and integral calculus for an exam next month.” The server collects prior learning data and finds that the user has high accuracy in basic differentiation problems but low accuracy and long response times in differential equations. The server also observes emotion indices indicating elevated anxiety when the user attempts multi-step word problems in differential equations. The server composes an internal prompt sentence such as:

“The learner has a strong understanding of basic differentiation (accuracy 90%, short average response times), a moderate understanding of basic integration (accuracy 70%), and a weak understanding of differential equations (accuracy 40%, long average response times). The learner's emotion indices indicate high anxiety for multi-step word problems in differential equations. Generate a sequence of 5 learning sessions that gradually build confidence in differential equations, starting from simple worked examples and progressing to more complex problems. For each session, specify the main activity type and difficulty level. Also generate a short encouraging feedback message suitable for a learner who feels anxious about these problems.”

The generative AI model outputs text describing five sessions and an encouraging message. The server parses the sessions, maps them to internal content identifiers, selects suitable concrete learning content, and constructs user interface prompt sentences such as:
“You seem to feel anxious about differential equation word problems. Would you like to start with three simple worked examples to build your confidence?”

The learner terminal displays this prompt, and the user confirms. The learner terminal then loads the selected examples, and the user proceeds through them. The server monitors performance and emotion indices during and after these exercises. If understanding degree improves and emotion load decreases, the server updates learning state information accordingly and may generate a new internal prompt sentence asking the generative AI model to propose a transition to standard-difficulty problems.

Because the server uses structured learning state information, automatically synthesized internal prompt sentences, and deterministic parsing of model outputs, the system implements a specific, non-generic improvement in computer-based control of learning content delivery. The system reduces unnecessary recomputation and network transmissions, increases the precision of recommendation and feedback generation, and enables real-time personalization that is not achievable by straightforward automation of human-designed static rules.

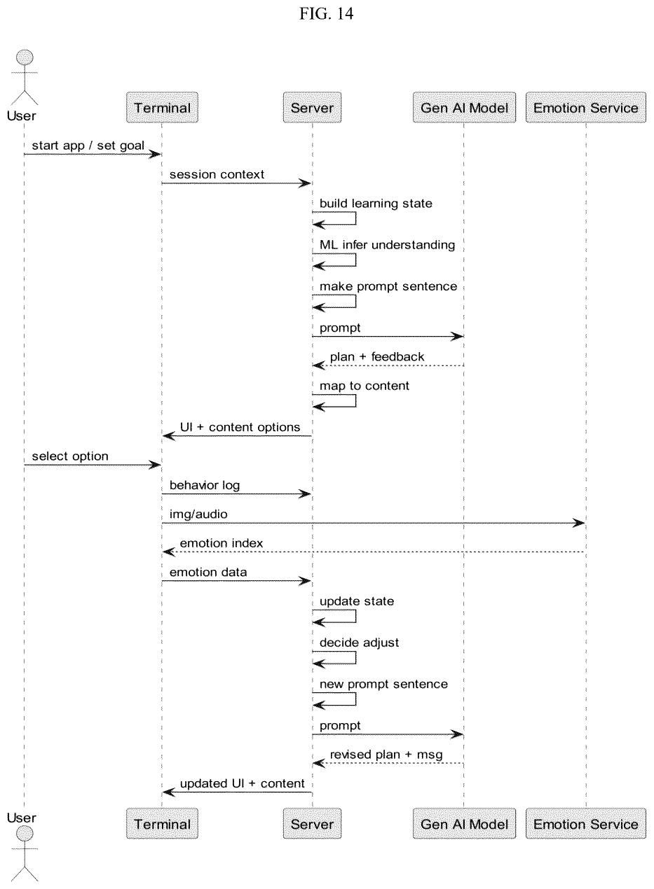

The following describes the processing flow using FIG. 14.

### Step 1

User starts a learning session and provides initial information.

User operates the terminal to launch a learning application and select a subject or goal, such as “calculus” or “score 80 or higher on the next math exam.” The input in this step is user-entered data including goal text, subject selection, and, optionally, preferred study time or deadline. Terminal converts this input into structured fields (for example, goal type, target score, target date, selected topic IDs) and attaches device ID and learner ID. The output of this step is a structured learning-session request that terminal sends to server via a network connection.

### Step 2

Terminal sends session context and existing local history to server.

Terminal retrieves locally cached learning history, such as recent problems attempted while offline, last viewed content ID, and local timestamps. The input here is the structured learning-session request from Step 1 and any local activity logs that have not yet been synchronized. Terminal aggregates these into a JSON or similar data structure and performs basic data formatting (for example, normalizing timestamps to a standard time zone). The output is a session-context message including goal information, recent history, and identifiers, which terminal transmits to server over a secure communication channel.

### Step 3

Server authenticates the learner and stores initial session records.

Server receives the session-context message as input. Server verifies learner credentials (for example, using a token or session ID) and looks up the learner record in a database. Server then inserts or updates a session record containing learner ID, goal information, device information, and session start time. Server stores any new local history entries into a learning activity table, ensuring that primary keys and foreign keys are maintained. The output is a confirmed session context and a set of normalized learning activity records persisted in the database.

### Step 4

Server aggregates learning history and builds numerical learning state information.

Server uses learner ID as input key to query the database for all relevant learning activity records, including problem IDs, correctness flags, timestamps, and content IDs. Server sorts activities chronologically and groups them by learning unit ID. Server computes, for each learning unit, correctness rate (number of correct answers divided by total attempts), average response time (difference between start and end timestamps), and attempt count. Server also computes recency-weighted statistics (for example, applying exponential decay to older attempts). The data processing performed here includes summations, divisions, time-difference calculations, and exponential-weighting operations using numerical libraries. The output is a learning state structure: a table or in-memory dictionary that maps each learning unit ID to a feature vector containing correctness rate, mean response time, attempt count, and recency scores.

### Step 5

Server infers understanding degree and priority learning units using a machine learning model.

Server takes the learning state structure from Step 4 as input. For each learning unit, server converts the feature vector into a standardized input tensor by scaling numeric values (for example, z-score normalization) and encoding categorical fields (for example, one-hot or embedding indices). Server feeds these tensors into a pre-trained neural network model implemented in a machine learning framework. The neural network computes linear transformations, applies non-linear activation functions, and propagates activations through hidden layers to generate output scores representing predicted understanding degrees and priority flags. The output of this step is a set of understanding degree values (for example, in the range 0.0-1.0) and binary or graded indicators that mark learning units as “priority for review” or “not priority.”

### Step 6

Server generates an internal prompt sentence for the generative AI model.

Server uses as input the learning goal information from Step 3 and the understanding degree and priority information from Step 5. Server constructs a text template and fills it with concrete values: subject name, target score, remaining days, top strengths, and top weaknesses. Data processing here includes sorting learning units by understanding degree, selecting the top N strong and weak units, and converting numeric scores into descriptive phrases (for example, “accuracy 40%, long response time”). Server then concatenates these phrases into an internal prompt sentence. An example internal prompt sentence is:
“The learner's goal is to score at least 80 on a mathematics exam in 4 weeks. The learner is strong in basic differentiation (accuracy 90%, short response times), moderate in integration by substitution (accuracy 65%), and weak in differential equations (accuracy 40%, long response times). Generate a 5-session learning plan focusing on improving differential equations, specify activity types for each session, and produce one short encouraging feedback message.”

The output is a complete internal prompt sentence string ready to be sent to the generative AI model.

### Step 7

Server requests a learning plan and feedback from the generative AI model.

Server takes the internal prompt sentence from Step 6 as input, tokenizes it into a sequence of tokens, and sends these tokens to a generative AI model endpoint via an API call. Inside the model, attention mechanisms and feed-forward operations transform the token sequence into contextualized embeddings and generate a probability distribution for each subsequent token. Server selects tokens according to a decoding strategy such as greedy decoding or top-k sampling, but this internal model process is encapsulated in the AI service. The output received by server is generated text that typically includes a structured description of multiple sessions and one or more feedback messages.

### Step 8

Server parses the generative AI model output into structured plan data.

Server treats the generated text from Step 7 as input. Server applies parsing rules and text pattern recognition (for example, detecting “Session 1:”, “Session 2:”, and “Feedback:”) to segment the output. For each session description, server extracts topic names, difficulty indicators (for example, “easy,” “medium,” “hard”), and activity types (for example, “worked example,” “practice problems,” “quiz”). Server then maps textual topic names to internal learning unit IDs using a topic dictionary table stored in the database. This mapping involves string normalization (lowercasing, trimming) and dictionary lookup; if multiple matches exist, server may choose the closest match based on similarity measures. The output of this step is structured learning plan information, where each session entry is represented as a record containing learning unit IDs, target difficulty levels, and activity types, plus associated feedback text segments.

### Step 9

Server selects concrete learning content for each plan entry.

Server takes the structured learning plan information from Step 8 as input and queries a learning content storage unit. For each session entry, server searches a content table using learning unit ID, difficulty level, and activity type as query parameters. Server may compute a ranking score for candidate content based on past effectiveness metrics (for example, historical improvement associated with that content), content length, and media type (for example, text, video). Data processing here includes filtering, joining, and sorting database records. The output is individualized optimized learning content information: a list of specific content IDs and associated metadata (title, type, difficulty) for each planned session element.

### Step 10

Server generates user-facing prompt sentences and sends them to the terminal.

Server uses as input the individualized optimized learning content information and the feedback text obtained or synthesized in Step 8. Server constructs natural-language prompt sentences tailored to the learner's weaknesses and planned activities. For example, server may generate:
“Would you like to start with three easy practice problems on first-order differential equations?”
“Do you want to review a simple worked example before attempting a more complex problem?”

Server packages these prompt sentences together with content IDs and control flags (for example, default action, button labels) into a response message. The output is a UI payload that server transmits to terminal via a network response.

### Step 11

Terminal renders the prompt sentences and content options to the user.

Terminal receives the UI payload from Step 10 as input. Terminal parses the payload, creates visual components such as dialog boxes, buttons, and lists of recommended content, and associates each button with the corresponding content ID and action. Terminal draws these components on the display, showing prompt sentences and choice options. No heavy data computation is performed here beyond UI layout and event binding. The output of this step is a visible user interface displayed to user, ready for interaction.

### Step 12

User selects an option and begins interacting with recommended content.

User views the prompt sentences displayed by terminal and selects an option, such as pressing a button labeled “Start easy practice” or “Show example.” The input in this step is the rendered UI and the user's conscious decision. Terminal records the selection event and loads the content associated with the chosen content ID. Terminal fetches the corresponding learning content (if not already cached) and renders it on the display as text, images, or interactive problems. The output is both immediate content presentation to user and an interaction event recorded internally by terminal.

### Step 13

Terminal logs detailed learning behavior and sends it to server.

Terminal uses the user's interactions with the content from Step 12 as input. Terminal records problem IDs, user answers, correctness (when evaluated locally), timestamps for content opening and closing, and screen transitions. Terminal organizes these data into a learning behavior log entry, performing simple computations such as response time (difference between answer timestamp and question display timestamp). Terminal then sends the log entries to server at defined intervals or when a problem is completed. The output is a batch of structured learning behavior log records transmitted to server.

### Step 14

Terminal acquires image and audio data and estimates emotion indices.

Terminal uses the ongoing content interaction context and sensor hardware as input. With user consent, terminal captures image frames through the camera and audio segments through the microphone while user solves problems or reads explanations. Terminal applies computer vision and audio processing functions: detecting facial landmarks, estimating expression scores (for example, smile intensity, brow furrow), and computing acoustic features (for example, pitch, energy, speech rate). Terminal either converts these features into emotion index values locally via a lightweight model or sends the features to an external emotion analysis service and receives emotion index values. The output is a time-stamped set of emotion index values (such as “anxiety: 0.7, frustration: 0.6, joy: 0.2”) associated with specific activity IDs, which terminal transmits to server.

### Step 15

Server integrates behavior logs and emotion indices into updated learning state information. Server receives the learning behavior log records from Step 13 and the emotion index values from Step 14 as input. Server aligns these records by matching timestamps and content IDs and associates them with corresponding learning units. Server recomputes aggregated metrics for each learning unit, including updated correctness rates and response times. Server also aggregates emotion indices over multiple events to estimate average or peak emotion states per learning unit. Data processing includes weighted averaging, normalization, and temporal association. The output is updated learning state information, now containing both cognitive performance metrics and emotion load indicators.

### Step 16

Server determines difficulty adjustments and auxiliary material needs.

Server takes the updated learning state information from Step 15 as input. Server applies rule-based logic or a secondary model to classify each learning unit according to combinations of understanding degree and emotion load. For example, if understanding degree is below a threshold and average “anxiety” score exceeds a threshold, server sets a rule outcome to “reduce difficulty and add worked examples.” If understanding degree is moderate and emotion load is low, server sets “maintain or slightly increase difficulty.” Data computation includes comparing numeric values to thresholds and evaluating logical conditions. The output of this step is control information: difficulty adjustment information, presentation order change information, and additional auxiliary material selection information per learning unit.

### Step 17

Server composes a new internal prompt sentence including emotion context.

Server uses as input the updated learning state information and the control information from Step 16. Server selects representative examples of learning units where difficulty or order changes are needed and summarizes their understanding degrees and emotion loads. Server then constructs a new internal prompt sentence such as:
“The learner is struggling with differential equations (accuracy 40%, long response times) and shows high anxiety (average anxiety score 0.8) for these problems. Modify the existing learning plan to introduce simpler worked examples and low-difficulty practice problems for differential equations before reintroducing standard-difficulty problems. Also generate a short, supportive message that reassures the learner.”

The data processing involves selecting and formatting metrics into text and combining them with instructions about plan modification and message tone. The output is a new internal prompt sentence capturing both cognitive and affective status and explicit modification instructions.

### Step 18

Server updates the learning plan and feedback using the generative AI model.

Server sends the new internal prompt sentence from Step 17 as input to the generative AI model via an API call. The model generates revised plan segments and an encouraging message. Server receives the generated text and parses it similarly to Step 8, extracting new or modified sessions and feedback content. Server then merges these revisions into the existing learning plan, replacing or appending certain session elements as indicated by the output text and control information. Data operations include list updates, merging, and consistency checks to ensure that each plan element references valid learning units. The output is updated learning plan information and updated learning feedback information reflecting both the learner's performance and emotion state.

### Step 19

Server sends updated plan, feedback, and new user-facing prompt sentences to terminal. Server takes the updated learning plan and feedback information from Step 18 as input. Server generates new user-facing prompt sentences that describe the change in plan and offer choices to user, such as:
“This problem set seems challenging. Would you like to review a simpler example first?” “Based on your recent progress, you can now try standard-difficulty problems or continue with easier ones. Which do you prefer?”

Server again packages these prompt sentences, together with associated content IDs and control flags, into a response payload. The output is a new UI payload that server transmits to terminal to drive the next phase of interaction.

### Step 20

Terminal presents updated guidance and continues the interaction cycle.

Terminal receives the new UI payload from Step 19 as input. Terminal updates the interface to show the revised prompt sentences and options. User then makes a new choice, leading to new content loading and new logs. Terminal records these actions, repeats the logging and sensor capture processes, and continues sending updated logs and emotion indices to server. The output of this step is continued user interaction, new behavior and emotion data, and a repeated feedback loop that allows server to iteratively refine learning plans and feedback in real time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

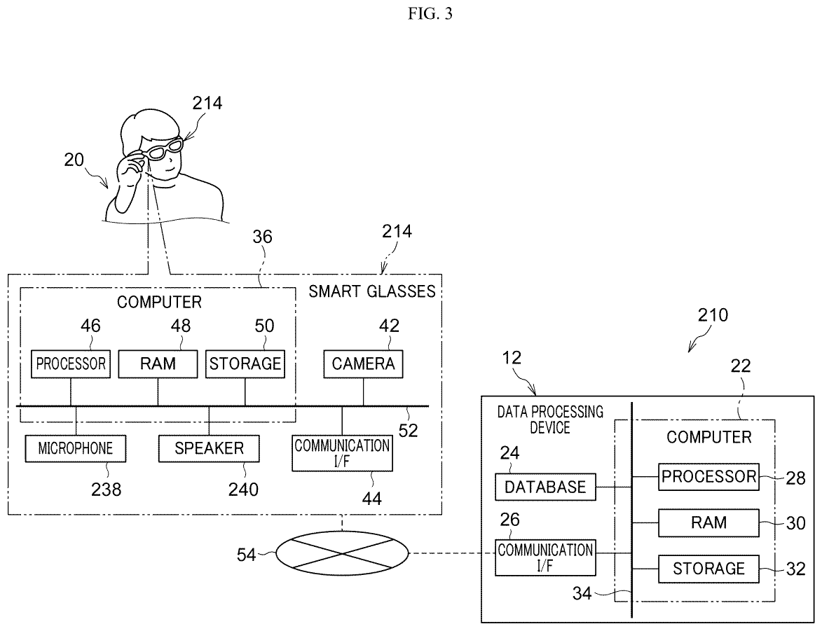

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

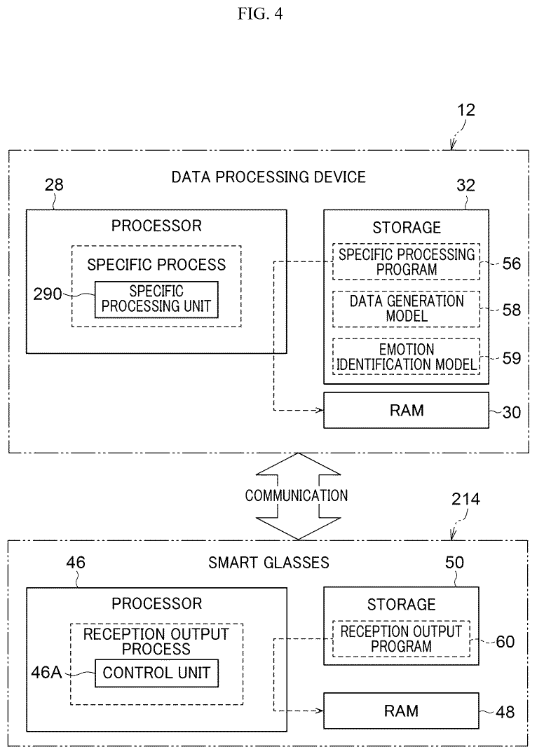

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

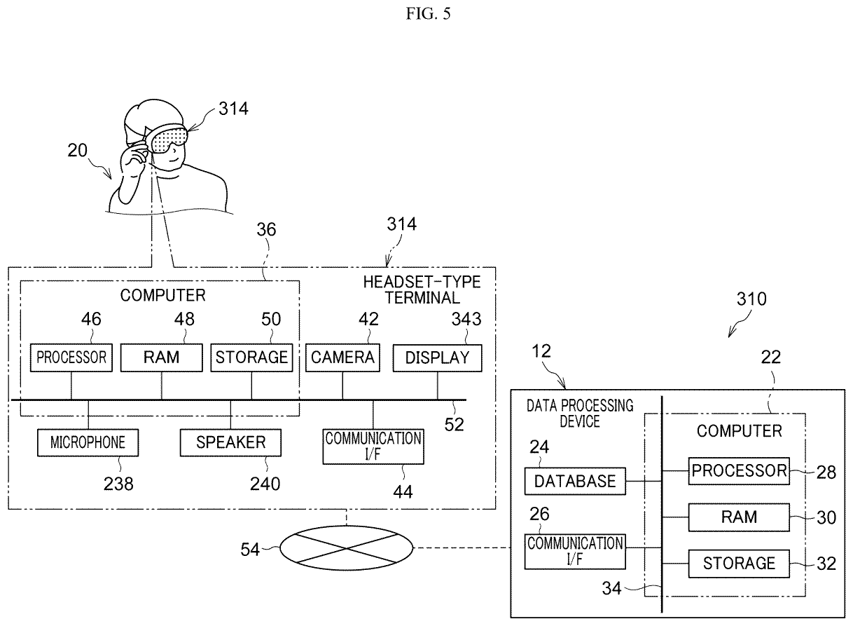

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

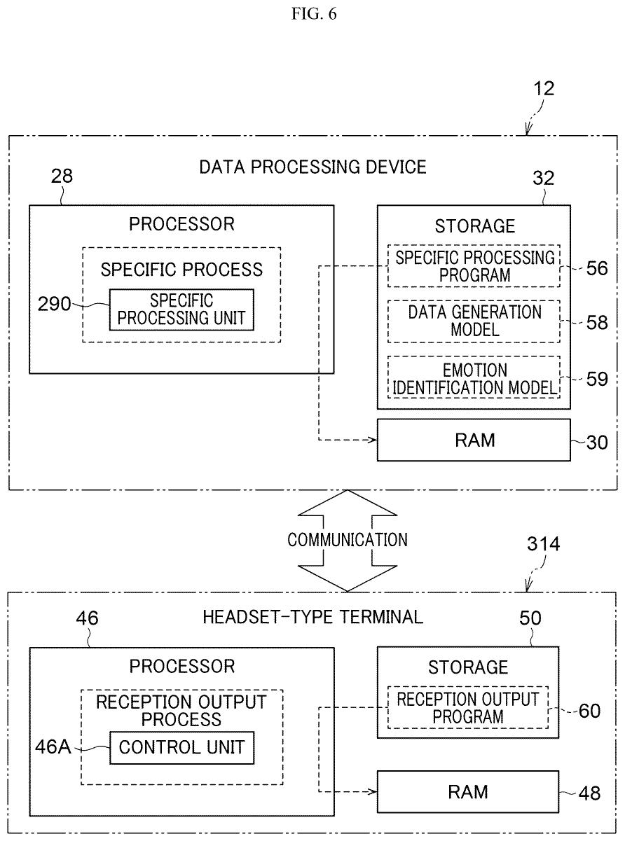

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

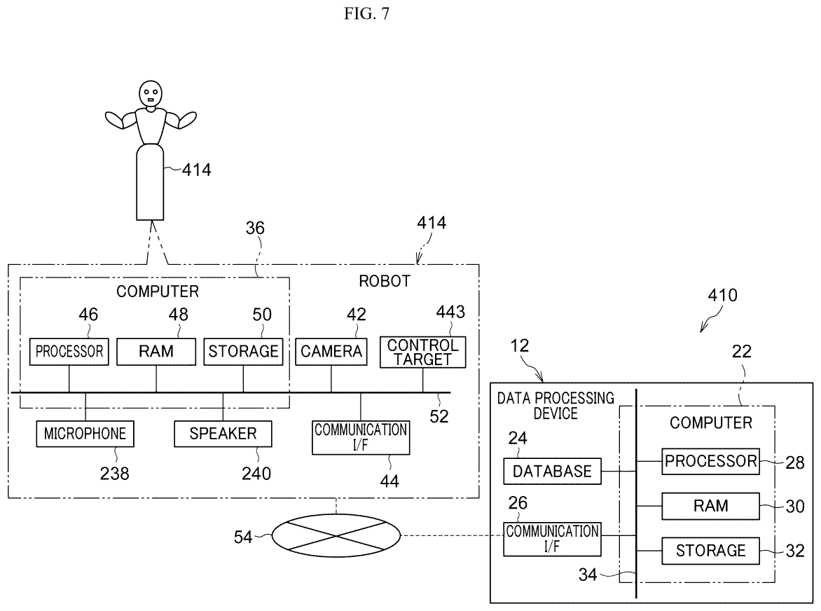

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

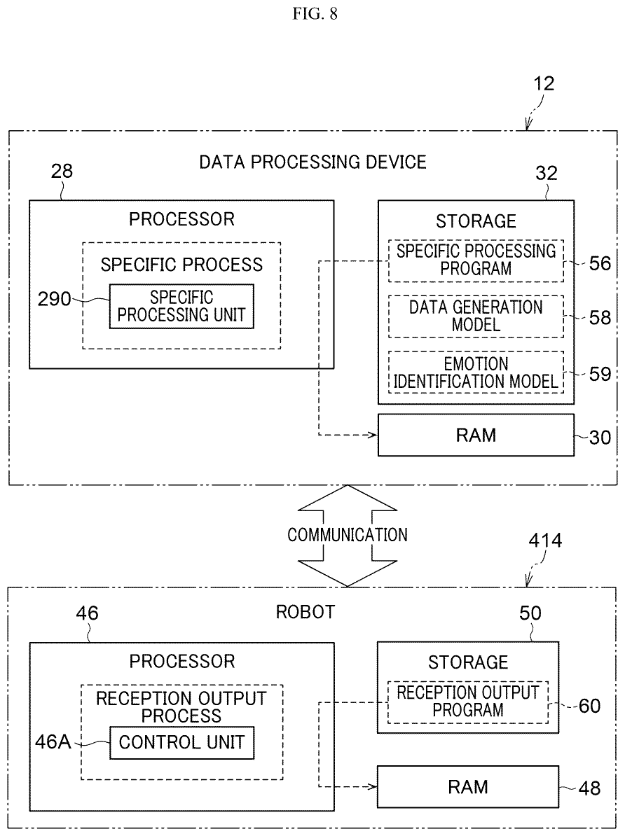

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

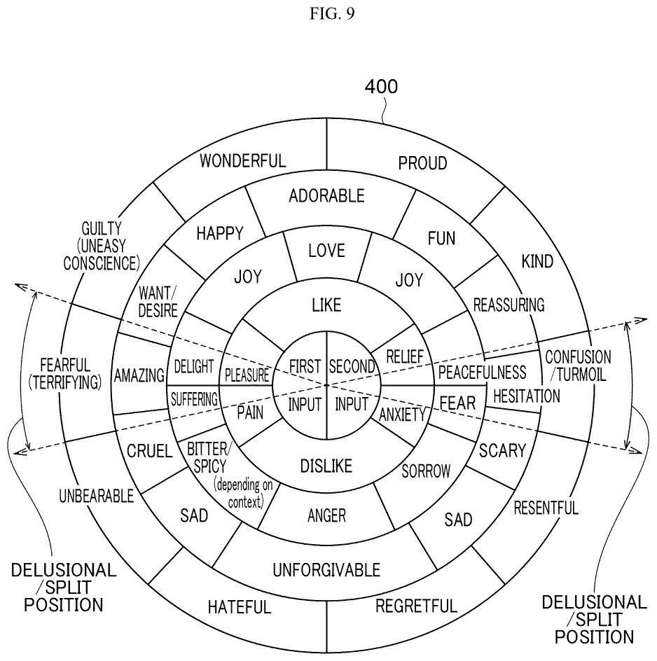

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

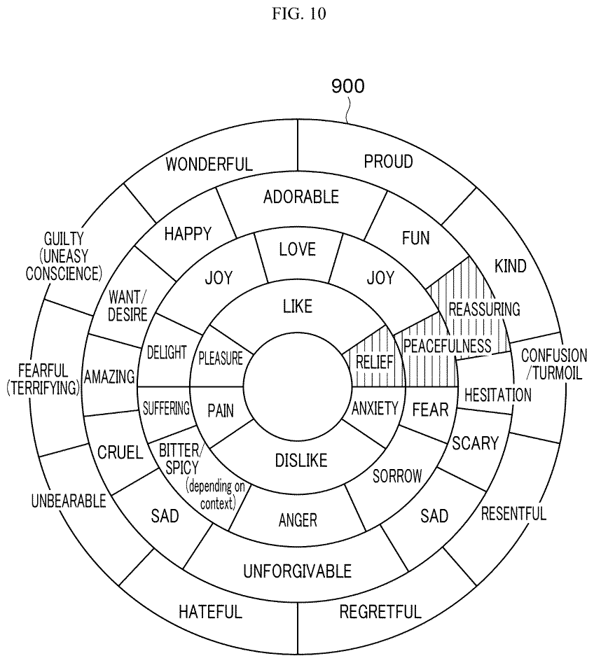

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire input information regarding a learning objective from a learning terminal operated by a learner, and associate the input information with learner identification information and with learning history information and performance information stored in a learner information storage unit,
acquire, from the learner information storage unit, subject-wise or unit-wise performance information and study-time information based on the learner identification information, and generate, by aggregating or classifying the performance information and the study-time information, degree-of-mastery information for each learning field,
generate a first prompt sentence to be input to a generative AI model based on the learning objective, the degree-of-mastery information, and the learning history information, the first prompt sentence instructing the generative AI model to perform identification processing of strong fields and weak fields among the learning fields,
input the first prompt sentence and the degree-of-mastery information to the generative AI model, and obtain analysis-result information including the strong fields and the weak fields among the learning fields, by natural language processing and statistical estimation processing performed by the generative AI model,
generate a second prompt sentence for instructing the generative AI model to generate personalized learning-plan information including a learning period, allocation of study time, and learning contents for each learning field, based on the analysis-result information and the learning objective, input the second prompt sentence to the generative AI model, and obtain the learning-plan information from the generative AI model,
transmit the learning-plan information to the learning terminal and cause the learning terminal to display the learning-plan information as learning tasks on a daily basis or a session basis,
acquire, from the learning terminal, progress information including achievement status of the learning tasks executed by the learner based on the learning-plan information, additional performance information, and self-evaluation information, and sequentially store the progress information in the learner information storage unit,
generate a third prompt sentence for instructing the generative AI model to update or modify the learning-plan information based on updated learning history information and performance information including the progress information, input the third prompt sentence to the generative AI model, and cause the generative AI model to generate updated learning-plan information and feedback information corresponding to a remaining period, and
transmit the updated learning-plan information and the feedback information to the learning terminal and cause the learning terminal to provide a personalized learning experience for each learner.

### Supplementary 2

The system according to supplementary 1,
wherein the processor is configured to
specify, in at least one of the first prompt sentence and the second prompt sentence input to the generative AI model, evaluation criteria aimed at maximizing learning outcome, improving learning efficiency, and enhancing degree of understanding of the learner, and instruct the generative AI model to adjust difficulty level of learning tasks, distribution of question fields, and review frequency based on the evaluation criteria.

### Supplementary 3

The system according to supplementary 1,
wherein the processor is configured to
in a case where no explicit learning objective input is provided by the learner, input to the generative AI model a prompt sentence for generating candidate learning objectives based on the learning history information and the performance information, acquire the candidate learning objectives from the generative AI model, and present the candidate learning objectives together with the learning-plan information to the learning terminal.

### Application Example 1

### Supplementary 1

A system comprising a processor,
wherein the processor is configured to
acquire learner information including goal information and ability information of a learner, structure the learner information, and generate learning requirement data indicating learning tasks and available time of the learner based on the learner information,
generate, by using the learning requirement data and historical learning data including past performance data, a prompt sentence in a natural language describing conditions relating to learning content, learning period, and learning allocation necessary for achieving a goal of the learner, and generate input data for a generative AI model, the input data including generation instruction data containing the prompt sentence,
obtain, from the generative AI model, a learning plan text in the natural language generated in response to the prompt sentence, and analyze the learning plan text to convert the learning plan text into structured learning plan data including at least one of a daily or weekly learning date and time, a learning target domain, a learning time, and a learning content type,
search, based on at least the learning target domain, a difficulty level, and the learning time included in the structured learning plan data, a plurality of learning resource metadata stored in a learning resource database, select specific learning resources corresponding to respective learning units included in the structured learning plan data, and generate a personalized learning resource list,
generate delivery data for presenting the structured learning plan data and the learning resource list to the learner via a terminal device, and transmit the delivery data to the terminal device via a communication path,
receive learning progress data from the terminal device, and generate learning status analysis data by calculating, based on the learning progress data, at least one of a domain-specific achievement index and a progress index for each learner,
generate, by using the learning status analysis data, a prompt sentence to instruct the generative AI model to generate feedback and plan adjustment content according to a learning status, input generation instruction data including the prompt sentence into the generative AI model, and obtain, from the generative AI model, a feedback text and an updated learning plan text as an output,
analyze the feedback text and the updated learning plan text to generate updated structured learning plan data, re-search the learning resource database to generate an updated learning resource list, and provide, by redistributing the updated structured learning plan data and the updated learning resource list to the terminal device, a dynamically changing personalized learning experience for each learner, and
acquire emotion-related data including at least one of behavior information and response information of the learner, generate emotion analysis data by estimating an emotion state of the learner based on the emotion-related data, generate, by using the emotion analysis data, a prompt sentence to instruct the generative AI model to optimize the learning plan and the learning resources, and correct the learning plan and feedback content based on a generation result obtained in response to the prompt sentence.

### Supplementary 2

The system according to supplementary 1,
wherein the processor is configured to
generate a prompt sentence by using the structured learning plan data and the learning status analysis data to instruct the generative AI model to provide an efficient and effective learning experience for maximizing learning outcomes of the learner, and include the prompt sentence in the generation instruction data to be input to the generative AI model.

### Supplementary 3

The system according to supplementary 1,
wherein the processor is configured to
when goal information input by the learner is insufficient or when it is determined, based on the learning status analysis data, that a review of the goal is necessary, generate a prompt sentence to cause the generative AI model to generate candidate learning goals achievable based on attribute information of the learner and the historical learning data, and present, to the learner, the candidate learning goals obtained as a generation result in response to the prompt sentence so as to support learning planning and goal setting.

### Example 2

### Supplementary 1

A system comprising a processor,
wherein the processor is configured to
acquire information regarding learning activities of a learner from a terminal, and store the information in a storage device,
aggregate and preprocess the stored learning activity information, and generate feature data representing a learning history for each learner,
acquire a prompt sentence indicating a learning objective of the learner from the terminal, and construct model input information by integrating the feature data based on the learning history and the prompt sentence,
provide an instruction to a generative AI model by using the model input information so as to cause the generative AI model to generate learning proposal information including learning materials and learning tasks individually optimized for each learner,
identify learning materials and learning tasks included in the learning proposal information by using identification information, acquire corresponding learning resources from a learning resource storage device, and generate structured data in which the learning resources are associated with the learning proposal information,
transmit the generated structured data as the learning proposal information to the terminal via a communication device so that the terminal presents the learning proposal information to the learner,
acquire, from the terminal, feedback information including learning activity results of the learner and evaluations of understanding and difficulty, store the feedback information in association with the learning activity information, and update the feature data,
dynamically change contents of instructions to the generative AI model based on the updated feature data and a new prompt sentence, and thereby continuously personalize learning proposal information to correspond to a state of the learner,
analyze a learning progress of the learner based on the learning activity information and the feedback information, and cause the generative AI model to generate, by using an analysis result as additional context, feedback messages and modification proposals of a learning plan based on the analysis result,
acquire emotion-related data representing an emotional state of the learner, analyze the emotion-related data to generate an emotional state index, and provide an instruction to the generative AI model by using model input information including the emotional state index so as to optimize contents and difficulty levels of the learning plan and the learning materials, and
transmit, to the terminal, emotion-response feedback and motivation messages generated by the generative AI model based on the emotional state index and the learning progress analysis result so that the terminal presents the emotion-response feedback and the motivation messages to the learner.

### Supplementary 2

The system according to supplementary 1,
wherein the processor is configured to
control contents and structures of the prompt sentence to the generative AI model based on the learning activity information, the feedback information, and the emotional state index so as to provide an efficient and effective learning experience that enhances a learning outcome of the learner.

### Supplementary 3

The system according to supplementary 1,
wherein the processor is configured to
generate learning objectives and an achievement order of the learning objectives by using goal information of the learner, the feature data based on the learning history, and the prompt sentence, provide an instruction to the generative AI model to generate a learning plan including the learning objectives, and cause the terminal to present the learning plan.

### Application Example 2

### Supplementary 1

A system comprising a processor,
wherein the processor is configured to
acquire learner attribute information, learning goal information, and learning history information, arrange the learning history information in chronological order, calculate, for each learning unit, correctness rate information, response time information, and learning frequency information, and store the calculated information as learning state information, convert the learning state information into numerical data and calculate, by using a machine learning model, understanding degree information for each learning unit and priority learning unit information,
generate an internal prompt sentence to be input to a generative information processing model on the basis of the understanding degree information, the priority learning unit information, and the learning goal information, and transmit inquiry data including the internal prompt sentence to the generative information processing model,
analyze output data obtained from the generative information processing model, extract learning plan information for learning sessions, learning material candidate information, and learning feedback candidate information, and select, from a learning content storage unit, concrete learning content corresponding to the learning material candidate information to construct individualized optimized learning content information,
generate, on the basis of the individualized optimized learning content information and the learning feedback candidate information, a user interface prompt sentence for presentation on a learner terminal, and transmit the user interface prompt sentence to the learner terminal, acquire, from the learner terminal, learning behavior log information including browsing operation information for learning content, problem answer result information, screen transition information, and time information corresponding to the browsing operation information and the problem answer result information, and update the learning state information,
acquire, from the learner terminal or from an external emotion analysis service, image information, audio information, or emotion index information calculated from the image information or the audio information, and estimate emotion state information during learning by associating the acquired information with the learning behavior log information,
calculate emotion load information for each learning unit by associating the emotion state information with the understanding degree information, and generate difficulty adjustment information, presentation order change information, and additional auxiliary material selection information on the basis of updated learning state information including the emotion load information,
generate, on the basis of the updated learning state information and the difficulty adjustment information, a new internal prompt sentence that takes into account the emotion state and learning progress, instruct the generative information processing model, by using the new internal prompt sentence, to perform modification of a learning plan and generation of an encouraging message, and dynamically update learning plan information and learning feedback information on the basis of an output result from the generative information processing model, and
transmit, to the learner terminal, the updated learning plan information, the learning feedback information, and a prompt sentence for allowing the learner to select among the updated learning plan information and the learning feedback information, and repeatedly perform presentation of learning content and presentation of feedback during a learning session.

### Supplementary 2

The system according to supplementary 1,
wherein the processor is configured to
instruct the generative information processing model, by using an internal prompt sentence including learning period information and target achievement value information, to generate learning session allocation information and learning amount allocation information on a weekly or daily basis, and create long-term learning plan information for maximizing learning efficiency and learning outcome based on an output result from the generative information processing model.

### Supplementary 3

The system according to supplementary 1,
wherein the processor is configured to
use an internal prompt sentence to cause the generative information processing model to generate specific learning goal candidates and evaluation index candidates based on ambiguous preference information or free-description goal information acquired from a learner, automatically generate the learning goal information based on an output result from the generative information processing model, and present the learning goal information to the learner terminal.

What is claimed is:

1. A system comprising:
circuitry configured to:
receive, via a communication interface coupled to a packet-switched network, request data representing an objective from a terminal device, associate the request data with identification information and with history information and performance information stored in a storage device, and generate proficiency information for each field by aggregating field-wise performance information and activity-time information retrieved from the storage device;
generate a first prompt sentence instructing a generative neural network model to identify high-performance fields and low-performance fields among the fields based on the objective, the proficiency information, and the history information, transmit the first prompt sentence and the proficiency information to the generative neural network model via the communication interface, and obtain analysis-result information comprising the high-performance fields and the low-performance fields;
generate a second prompt sentence instructing the generative neural network model to generate personalized plan information comprising a period, allocation of time, and content for each field based on the analysis-result information and the objective, transmit the second prompt sentence to the generative neural network model, obtain the plan information, and transmit the plan information to the terminal device via the communication interface;
receive, via the communication interface, progress information comprising achievement status of tasks executed based on the plan information, additional performance information, and self-evaluation information from the terminal device, and store the progress information in the storage device as updated history information and updated performance information; and
generate a third prompt sentence instructing the generative neural network model to update or modify the plan information based on the updated history information and the updated performance information, transmit the third prompt sentence to the generative neural network model, obtain updated plan information and feedback information, and transmit the updated plan information and the feedback information to the terminal device via the communication interface.

2. The system according to claim 1, wherein the circuitry is configured to acquire, from the terminal device via the communication interface, sensor data or interaction log data representing an emotional state of a user, perform emotional analysis to detect the emotional state, generate an emotion-adjustment prompt sentence instructing the generative neural network model to adjust a difficulty level, pacing, or content type of the plan information based on the detected emotional state, and transmit the emotion-adjustment prompt sentence to the generative neural network model.

3. The system according to claim 2, wherein the circuitry is configured to classify the detected emotional state into a plurality of predefined categories, apply a category-specific adjustment function to the difficulty level parameter of the plan information, and store the adjusted plan information in the storage device in association with the identification information and the detected emotional state category.

4. The system according to claim 2, wherein the circuitry is configured to generate an emotion-aware feedback prompt sentence encoding both the detected emotional state and a context derived from the analysis-result information, transmit the emotion-aware feedback prompt sentence to the generative neural network model, and transmit feedback information generated by the generative neural network model to the terminal device.

5. The system according to claim 1, wherein the circuitry is configured to generate, based on the proficiency information and the plan information, a content-specific prompt sentence instructing the generative neural network model to generate personalized task items specifying a difficulty level, a topic scope, and an output format, and to transmit task items obtained from the generative neural network model to the terminal device.

6. The system according to claim 5, wherein the circuitry is configured to apply a difficulty calibration function to the personalized task items by comparing a predicted difficulty score derived from the proficiency information against a target difficulty range specified in the plan information, and to regenerate the content-specific prompt sentence when the predicted difficulty score falls outside the target difficulty range.

7. The system according to claim 5, wherein the circuitry is configured to store the personalized task items in the storage device in association with the identification information and a session timestamp, and to retrieve stored task items and associated performance results for inclusion in the proficiency information computation for subsequent sessions.

8. The system according to claim 1, wherein the circuitry is configured to compute a first proficiency progression metric by comparing the proficiency information across a plurality of time periods, and to include the first proficiency progression metric as an additional input parameter in the second prompt sentence when the first proficiency progression metric indicates a monotone decline in a field.

9. The system according to claim 8, wherein the circuitry is configured to apply a field prioritization function to the updated plan information to increase the time allocation for fields exhibiting the monotone decline, and to transmit the reprioritized plan information to the terminal device as part of the updated plan information.

10. The system according to claim 1, wherein the circuitry is configured to apply a consistency validation function to the plan information obtained from the generative neural network model to verify that the period, time allocation, and content assignments satisfy a set of constraint conditions derived from the objective and the history information, and to regenerate the second prompt sentence with additional constraint specifications when a constraint violation is detected.

11. The system according to claim 10, wherein the circuitry is configured to limit constraint violation regeneration cycles to a maximum threshold, and to transmit partial plan information comprising successfully validated field assignments to the terminal device when the maximum threshold is reached.

12. The system according to claim 1, wherein the circuitry is configured to apply a self-evaluation weighting function to the self-evaluation information received in the progress information to adjust the contribution of the self-evaluation information relative to the achievement status data and the additional performance information when updating the history information and performance information in the storage device.

13. The system according to claim 12, wherein the circuitry is configured to apply a calibration function that compares the self-evaluation information against objective performance metrics derived from the achievement status data, computes a self-evaluation accuracy score, and adjusts the self-evaluation weighting function based on the self-evaluation accuracy score.

14. The system according to claim 1, wherein the circuitry is configured to generate a fourth prompt sentence instructing the generative neural network model to produce motivational messages based on a goal attainment percentage computed from the achievement status of tasks and the plan information, and to transmit the motivational messages to the terminal device in conjunction with the feedback information.

15. The system according to claim 14, wherein the circuitry is configured to apply a message personalization function to the motivational messages by incorporating user-specific vocabulary patterns derived from historical interaction logs stored in the storage device, and to store the personalized motivational messages in the storage device for subsequent retrieval.

16. The system according to claim 1, wherein the circuitry is configured to aggregate proficiency information across a plurality of identification information entries, compute field-level population statistics, and include the population statistics as a benchmark parameter in the first prompt sentence to enable relative performance assessment.

17. The system according to claim 16, wherein the circuitry is configured to apply a privacy-preserving aggregation function to the proficiency information of the plurality of identification information entries prior to computing the population statistics, and to store the aggregated statistics in the storage device separately from individual identification information.

18. A system comprising:
circuitry configured to:
receive, via a communication interface coupled to a packet-switched network, request data representing an objective from a terminal device, retrieve history information and performance information associated with identification information from a storage device, and generate proficiency information for each field by aggregating field-wise performance information and activity-time information from the storage device;
generate a first prompt sentence based on the objective, the proficiency information, and the history information to instruct a generative neural network model to identify high-performance and low-performance fields, transmit the first prompt sentence and the proficiency information to the generative neural network model via the communication interface, and obtain analysis-result information;
generate a second prompt sentence based on the analysis-result information and the objective to instruct the generative neural network model to generate plan information comprising a period, time allocation, and field-specific content, transmit the second prompt sentence to the generative neural network model, and transmit the obtained plan information to the terminal device;
receive progress information comprising achievement status, additional performance information, and self-evaluation information from the terminal device via the communication interface, and store the progress information as updated history information and updated performance information in the storage device; and
generate a third prompt sentence based on the updated history information and updated performance information to instruct the generative neural network model to generate updated plan information and feedback information, transmit the third prompt sentence to the generative neural network model, and transmit the updated plan information and the feedback information to the terminal device via the communication interface.

19. The system according to claim 18, wherein the circuitry is configured to acquire sensor data or interaction log data representing an emotional state of a user from the terminal device, perform emotional analysis to detect the emotional state, generate an emotion-adjustment prompt sentence instructing the generative neural network model to adjust a difficulty level or content type of the plan information based on the detected emotional state, and transmit the emotion-adjustment prompt sentence to the generative neural network model.

20. A method comprising:
receiving, via a communication interface coupled to a packet-switched network, request data representing an objective from a terminal device, associating the request data with identification information and with history information and performance information stored in a storage device, and generating proficiency information for each field by aggregating field-wise performance information and activity-time information;
generating a first prompt sentence instructing a generative neural network model to identify high-performance fields and low-performance fields based on the objective, the proficiency information, and the history information, transmitting the first prompt sentence and the proficiency information to the generative neural network model via a communication interface, and obtaining analysis-result information;
generating a second prompt sentence instructing the generative neural network model to generate personalized plan information comprising a period, time allocation, and content for each field based on the analysis-result information and the objective, transmitting the second prompt sentence to the generative neural network model, obtaining the plan information, and transmitting the plan information to the terminal device;
receiving, via the communication interface, progress information comprising achievement status, additional performance information, and self-evaluation information from the terminal device, and storing the progress information as updated history information and updated performance information in the storage device; and
generating a third prompt sentence instructing the generative neural network model to update or modify the plan information based on the updated history information and the updated performance information, transmitting the third prompt sentence to the generative neural network model, obtaining updated plan information and feedback information, and transmitting the updated plan information and the feedback information to the terminal device.
